(19) United States
(12) Patent Application Publication
(10) Pub. No.: US 2025/0005582 A1
(43) Pub. Date: Jan. 2, 2025

(54) SYSTEMS AND METHODS FOR REAL-TIME DYNAMIC SECURED PAYMENT INSTRUMENT PROCESSING

(71) Applicant: Synchrony Bank, Stamford, CT (US)

(72) Inventor: William Kievit, Stamford, CT (US)

(21) Appl. No.: 18/753,226

(22) Filed: Jun. 25, 2024

Related U.S. Application Data
(60) Provisional application No. 63/510,408, filed on Jun. 27, 2023.

(51) Int. Cl. G06Q 20/40; G06Q 20/32

(52) U.S. Cl. CPC G06Q 20/405; G06Q 20/3223; G06Q 20/401

(57) ABSTRACT

Systems and methods for automatically and dynamically adjusting credit limits associated with secured payment instruments in real-time as available balances corresponding to user accounts associated with mobile payment services change occur are provided. As transactions using a user account associated with a mobile payment service occur, the systems and methods provided obtain in real-time corresponding updates to the available balance associated with the user account. The systems and methods provided dynamically adjust the credit limit associated with a linked secured payment instrument in real-time according to the updates to the available balance.

### CROSS-REFERENCE TO RELATED APPLICATIONS

The present patent application claims the benefit of priority to U.S. Provisional Patent Application 63/510,408 filed Jun. 27, 2023, which is incorporated herein by reference in its entirety for all purposes.

### FIELD

The present disclosure relates generally to automatic and dynamic adjustment of a credit limit associated with a secured payment instrument in real-time as an available balance corresponding to a user account associated with a mobile payment service changes over time.

### SUMMARY

Disclosed embodiments provide a framework for automatically and dynamically adjusting a credit limit associated with a secured payment instrument as available balances corresponding to user accounts associated with one or more mobile payment services change over time. According to some embodiments, a computer-implemented method is provided. The computer-implemented method comprises receiving an application for a secured payment instrument. The application includes account information corresponding to a payment service account associated with a user. The computer-implemented method further comprises obtaining balance data associated with the user. The balance data corresponds to an available balance associated with the payment service account. Further, the balance data is obtained using the account information to access the payment service account. The computer-implemented method further comprises determining a credit limit associated with the secured payment instrument. The credit limit is determined based on the balance data. The computer-implemented method further comprises issuing the secured payment instrument. The secured payment instrument is secured according to the credit limit and an available balance associated with the payment service account. The computer-implemented method further comprises automatically obtaining new balance data associated with the payment service account. The new balance data is automatically obtained in real-time as transactions using the payment service account are performed. The computer-implemented method further comprises dynamically adjusting the credit limit associated with the secured payment instrument. The credit limit associated with the secured payment instrument is dynamically adjusted in real-time based on the new balance data.

In some embodiments, the computer-implemented method further comprises obtaining transaction data associated with the secured payment instrument. The transaction data is obtained in real-time as secured payment instrument transactions are performed. The computer-implemented method further comprises determining an amount of available credit associated with the secured payment instrument. The amount is determined based on the transaction data. The computer-implemented method further comprises providing the amount. When the amount is obtained by a payment service associated with the payment service account, the available balance is dynamically adjusted according to the amount.

In some embodiments, the computer-implemented method further comprises obtaining a credit evaluation corresponding to the user. The credit evaluation is obtained based on the application. The computer-implemented method further comprises using the credit evaluation to adjust the credit limit before issuing the secured payment instrument.

In some embodiments, the secured payment instrument is secured without a security deposit.

In some embodiments, the computer-implemented method further comprises dynamically training a machine learning algorithm to generate correlation functions for adjusting credit limits associated with different secured payment instruments as different balance data associated with different users is obtained. The machine learning algorithm is dynamically trained using a dataset of account characteristics. The computer-implemented method further comprises processing the balance data through the machine learning algorithm to identify a correlation function for the secured payment instrument. The computer-implemented method further comprises applying the correlation function based on the new balance data to dynamically adjust the credit limit.

In some embodiments, the credit limit is dynamically adjusted as a result of the new balance data indicating that the available balance is less than the credit limit.

In some embodiments, the computer-implemented method further comprises automatically tracking a credit performance associated with the user. The credit performance is tracked in real-time. The computer-implemented method further comprises dynamically adjusting the credit limit according to the credit performance.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a credit limit associated with a secured payment instrument is dynamically adjusted according to real-time balance data corresponding to user accounts associated with one or more mobile payment services in accordance with at least one embodiment;

FIG. 2 shows an illustrative example of an environment in which a balance management system dynamically determines an initial credit limit associated with a secured payment instrument based on available balances corresponding to user accounts associated with one or more mobile payment services in accordance with at least one embodiment;

FIG. 3 shows an illustrative example of an environment in which a balance management system dynamically adjusts a credit limit associated with a secured payment instrument and available balances corresponding to user accounts associated with one or more mobile payment services as transactions are processed in real-time in accordance with at least one embodiment;

FIG. 4 shows an illustrative example of an environment in which a real-time balance monitoring engine dynamically adjusts an available credit limit associated with a secured payment instrument in real-time based on transactions corresponding to a user account associated with a mobile payment service in accordance with at least one embodiment;

FIG. 5 shows an illustrative example of an environment in which a real-time balance monitoring engine transmits in real-time transaction data associated with a secured payment instrument to cause a mobile payment service to reduce an available balance associated with a user account according to the transaction data in accordance with at least one embodiment;

FIG. 6 shows an illustrative example of a process for establishing a secured payment instrument that is secured using available balances corresponding to user accounts associated with one or more mobile payment services in accordance with at least one embodiment;

FIG. 7 shows an illustrative example of a process for dynamically adjusting a credit limit associated with a secured payment instrument in real-time in response to changes to available balances corresponding user accounts associated with one or more mobile payment instruments in accordance with at least one embodiment;

FIG. 8 shows an illustrative example of a process for dynamically adjusting an available balance corresponding to a user account associated with a mobile payment service based on transaction data associated with a secured payment instrument in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for dynamically adjusting a credit limit associated with a secured payment instrument in real-time as an available balance corresponding to a user account associated with a mobile payment service changes over time. For instance, if the systems and methods described herein determine that an available balance corresponding to a user account associated with a mobile payment service is reduced as a result of transactions corresponding to the user account, the systems and methods may dynamically reduce the available credit limit associated with the secured payment instrument such that the credit limit associated with the secured payment instrument does not exceed the available balance corresponding to the user account. Similarly, as the amount of available credit associated with the secured payment instruments changes over time (such as through use of the secured payment instrument for different transactions), the systems and methods can provide transaction data corresponding to these changes to the mobile payment service to cause the mobile payment service to dynamically, and in real-time, adjust the available balance corresponding to the user account to ensure that sufficient funds are available for settlement of any balances associated with the secured payment instrument. This framework may provide for the constant securitization of a secured payment instrument using available balances from user accounts associated with mobile payment services.

A secured payment instrument, as described in greater detail herein, may be a payment instrument associated with an account that is secured using an available balance corresponding to a user account associated with a mobile payment service. As described in greater detail herein, as the available balance corresponding to the user account dynamically changes as transactions associated with the user account occur, the credit limit associated with the secured payment instrument may be reduced in real-time such that the new credit limit corresponds to the new available balance corresponding to the user account. Further, as the secured payment instrument is used for various transactions, resulting in a reduction in the available credit associated with the secured payment instrument, the amount of the available balance corresponding to the user account may be dynamically reduced according to these transactions. This may serve to ensure that funding is available from the user account to securitize any balances associated with the secured payment instrument.

As used herein and unless otherwise made expressly clear, “promotion” of a secured payment instrument to an unsecured payment instrument refers to the systems and methods described herein for graduating a secured payment instrument to an unsecured payment instrument rather than the conventional meaning of “promotion” (e.g., offering an incentive to promote participation or engagement with services associated with the payment instrument).

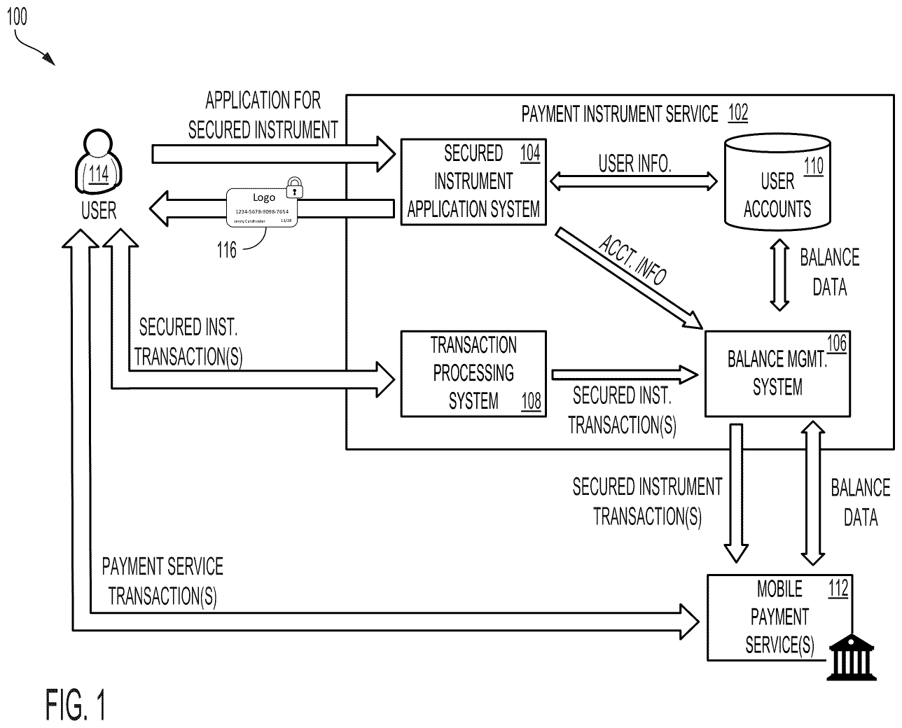

FIG. 1 shows an illustrative example of an environment 100 in which a credit limit associated with a secured payment instrument 116 is dynamically adjusted according to real-time balance data corresponding to user accounts associated with one or more mobile payment services 112 in accordance with at least one embodiment. In the environment 100, a user 114, through use of a computing device (e.g., smartphone, tablet computer, desktop computer, etc.), may submit an application or other request to a secured instrument application system 104 of a payment instrument service 102 to obtain a line of credit associated with a secured payment instrument 116. In an embodiment, the application or other request submitted by the user 114 includes information corresponding to one or more user accounts associated with one or more mobile payment services 112, such as account credentials (e.g., usernames, passwords, cryptographic tokens, account numbers, etc.) that may be used to access these one or more user accounts. Further, the application or other request may include information that may be used to perform a credit inquiry of the user's credit report to determine whether the user 114 is qualified for a line of credit associated with a secured payment instrument 116. For instance, through the application or other request, the user 114 may provide their legal name, birthdate, last four digits of their Social Security number, household income, and the like.

In some instances, the user 114 may be associated with an existing account associated with the payment instrument service 102 (e.g., a third-party payment instrument service, a merchant, etc.). For instance, the user 114 may have an existing account associated with the payment instrument service 102 whereby the user 114 may have one or more existing lines of credit associated with secured and/or unsecured payment instruments. If the user 114 is associated with an existing account associated with the payment instrument service 102, the secured instrument application system 104 may query a user accounts datastore 110 maintained by the payment instrument service 102 to obtain any required information from the user's account that may be used to supplement the application or other request to obtain a new line of credit associated with a secured payment instrument 116. For instance, if the user 114 has previously submitted information corresponding to one or more accounts associated with the mobile payment services 112, the secured instrument application system 104 may automatically obtain this information from the user accounts datastore 110. Similarly, the secured instrument application system 104 may obtain, from the user accounts datastore 110, any user information that may be used to perform the credit inquiry of the user's credit report.

In some instances, the user 114 may not have a pre-existing relationship with the payment instrument service 102. For instance, the user 114 may be a new customer that is interested in establishing a new line of credit through the payment instrument service 102. As an illustrative example, the user 114 may be presented with advertisements related to the payment instrument service 102, whereby the user 114 may be presented with different payment instrument options, including an option for a secured payment instrument 116, that may generally be available from the payment instrument service 102. These advertisements may be presented in the form of billboards, radio media, television or digital video media, banner advertisements, pop-up advertisements, and the like. In response to these advertisements, the user 114 may access the payment instrument service 102 to submit an application or other request to determine whether the user 114 is eligible for the secured payment instrument 116 offered by the payment instrument service 102.

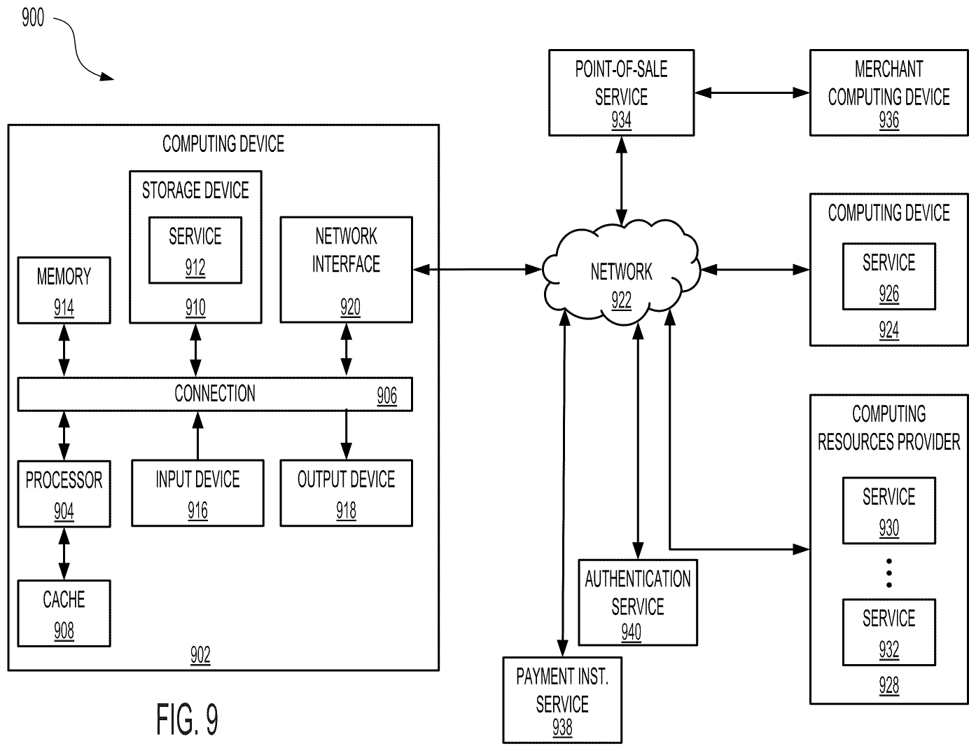

The payment instrument service 102, in an embodiment, is a service that, for example, processes applications for secured payment instruments, issues secured payment instruments, determines user-specific allowances to secure the secured payment instruments, processes transactions associated with secured payment instruments, determines whether a secured payment instrument should be graduated to an unsecured payment instrument, processes the graduation of the secured payment instrument to an unsecured payment instrument, issues unsecured payment instruments, processes transactions associated with unsecured payment instruments, processes cancellations of accounts associated with secured and unsecured payment instruments, and performs other such operations. In an embodiment, the payment instrument service 102 is a service such as the service 912 described herein at least in connection with FIG. 9. In an embodiment, the payment instrument service 102 is a service provided by a merchant such as the merchants described herein at least in connection with FIG. 9. In an embodiment, the payment instrument service 102 is a service provided by a computing resources provider such as the computing resource provide 928 described herein at least in connection with FIG. 9 (e.g., a service such as service 930 and/or service 932 described herein at least in connection with FIG. 9). In an embodiment, the payment instrument service 102 is a payment instrument service such as the payment instrument service 938 described herein at least in connection with FIG. 9. In some instances, the payment instrument service 102 may be a service operated by the issuer of the secured payment instrument and/or the unsecured payment instrument. In some instances, the payment instrument service 102 may be a service operated by a third-party on behalf of the issuer of the secured payment instrument and/or the unsecured payment instrument.

The secured instrument application system 104 may be implemented using a computer system of the payment instrument service 102. In some instances, the secured instrument application system 104 may be implemented as an application or executable process that is executed on a computer system of the payment instrument service 102. In an embodiment, if the user 114 has provided a set of credentials corresponding to an existing account associated with the payment instrument service 102, the secured instrument application system 104 may authenticate the provided set of credentials to ensure that the set of credentials correspond to the existing account and that the user 114 is authorized to access this existing account. If the set of credentials are successfully authenticated, the secured instrument application system 104 may access the user accounts datastore 110 to retrieve any information required for a credit inquiry of the user's credit report, as well as any information that may be used to access one or more other accounts associated with one or more mobile payment services 112, from the user's existing account. If the user 114 does not have an existing account associated with the payment instrument service 102, the secured instrument application system 104 may forego this process of accessing the user accounts datastore 110 to retrieve the required information from an existing account.

In an embodiment, the secured instrument application system 104 provides the provided application or other request, as well as any information garnered from the user accounts datastore 110, to a balance management system 106 of the payment instrument service 102. The balance management system 106 may be implemented using a computer system of the payment instrument service 102. In some instances, the balance management system 106 may be implemented as an application or executable process that is executed on a computer system of the payment instrument service 102. In an embodiment, the balance management system 106 automatically submits a credit inquiry to a credit reporting service to obtain a credit evaluation for the user 114. For instance, the result of credit inquiry may include one or more credit scores associated with the user 114, the current amount of credit allocated to the user 114 from different financial entities (including the payment instrument service 102, if any), the current amount of credit available to the user 114, and the like. The credit reporting service may be associated with one or more credit agencies (e.g., Equifax®, TransUnion®, Experian®, etc.) or may otherwise interact with one or more credit agencies to provide credit reporting to users and other entities (such as the balance management system 106).

In addition to obtaining a credit evaluation for the user 114, the balance management system 106 may automatically access one or more mobile payment services 112 to obtain balance data associated with one or more accounts maintained by these one or more mobile payment services 112 on behalf of the user 114. To automatically access an account associated with the user 114 and maintained by a mobile payment service 112, the balance management system 106 may use a corresponding set of credentials (e.g., usernames, passwords, cryptographic tokens, account numbers, routing numbers, etc.) associated with the account. For instance, through an application programming interface (API) call to a mobile payment service 112, the balance management system 106 may provide the mobile payment service 112 with the requisite set of credentials needed to access the account associated with the user 114. The mobile payment service 112 may evaluate the provided set of credentials in order to authenticate the request and determine whether the user 114 has provided the requisite authorization to allow the balance management system 106 to access the account.

A mobile payment service 112 may include a peer-to-peer (P2P) payment platform through which users may make payments to other peers and receive payments from other peers through different transactions within the P2P payment platform. For example, a user 114, through a mobile payment service 112, may submit a payment request to a friend to obtain a payment corresponding to a lunch meeting the user and their friend recently attended. In response to the payment request, the user's friend may transmit, through the mobile payment service 112, a payment to the user 114. In response to this payment, the mobile payment service 112 may automatically update the user's account associated with the mobile payment service 112 to indicate the amount received from the user's friend. This amount may be represented as a balance associated with the user account, which the user 114 may leverage for payments to other entities associated with the mobile payment service 112 or transfer to a linked account (e.g., bank account, credit union account, etc.).

As another illustrative example, a user 114, through the mobile payment service 112, may receive a payment request from a friend for an item purchased by the user 114. The payment request may indicate the amount request, an invoice corresponding to the item purchased by the user 114, and user information corresponding to the user's friend. The user 114, through the P2P payment platform provided by the mobile payment service 112, may review the payment request and determine whether to submit a payment to the requesting friend. Through the P2P payment platform, the user 114 may transmit the payment to the user's friend. The amount corresponding to this payment may be obtained from the user's available balance associated with their account maintained by the mobile payment service 112. In some instances, if the user 114 does not have an amount sufficient for the payment within their account maintained by the mobile payment service 112, the mobile payment service 112 may automatically obtain any required amounts from the user's linked account (e.g., bank account, credit union account, etc.) in order to provide the full payment to the user's friend. Thus, over time, the available balance corresponding to the user account maintained by the mobile payment service 112 may dynamically change in real-time as transactions involving the user account occur.

In an embodiment, if a mobile payment service 112 grants the balance management system 106 access to an existing account associated with the user 114, the balance management system 106 may automatically obtain balance data or other information that may be used to determine an existing balance corresponding to a user account associated with the mobile payment service 112. For instance, the balance management system 106 may submit a request to the mobile payment service 112 to obtain balance data or other information that may be used to determine an existing balance associated with the user account corresponding to the mobile payment service 112 and associated with the user 114. In an example, the balance data or other information may indicate the current balance associated with the user account. In another example, the balance data or other information may indicate any changes to the balance associated with the user account over a particular period of time (e.g., past six months, past year, past three years, etc.). These changes to the balance associated with the user account over the particular period of time may be used to determine an average balance associated with the user account over time.

In an embodiment, the balance management system 106 implements and dynamically trains a machine learning algorithm or artificial intelligence to automatically determine the initial credit limit and the correlation function (e.g., the function used to dynamically adjust the credit limit associated with the secured payment instrument 116 according to changes to the balance data) that is to be associated with the secured payment instrument 116 based on the balance data corresponding to the user account associated with the mobile payment service 112, the user's credit evaluation, and historical data corresponding to the user 114 and other users associated with the payment instrument service 102. The machine learning algorithm or artificial intelligence may be dynamically trained in real-time or near real-time using unsupervised learning techniques. For instance, a dataset of characteristics of accounts maintained by the payment instrument service 102 and users may be analyzed using the clustering algorithm to classify the obtained data according to one or more vectors of similarity (e.g., credit scores, changes in credit scores, balances corresponding to accounts associated with the mobile payment service 112, changes in balances corresponding to accounts associated with the mobile payment service 112, spending habits, total amount of credit allocated, total amount of credit available, payment performance, demographic information, etc.), similar accounts, and/or account holders associated with previously issued secured payment instruments. These similar accounts and/or account holders may correspond to different credit limit determinations as a function of available balances corresponding to user accounts associated with the mobile payment service 112. Further, these similar accounts and/or account holders may be identified based on the vectors of similarity. The dataset of characteristics of these accounts and users may, in an embodiment, further include historical data corresponding to the initial credit limits allocated to secured payment instruments issued to these users, any adjustments made to these credit limits over in response to transactions corresponding to user accounts associated with the mobile payment service 112 and changes to existing balances associated with these user accounts based on the transactions, and the like. Thus, in some embodiments, the balance management system 106, through the machine learning algorithm or artificial intelligence, can perform such clustering and obtain partial matches among other clusters of similar accounts and/or account holders according to these one or more vectors of similarity to identify a particular cluster and, from this cluster, identify the initial credit limit and the correlation function that is to be assigned for a new secured payment instrument 116.

In an embodiment, to dynamically train the machine learning algorithm or artificial intelligence used to identify initial credit limits and correlation functions for new secured payment instruments 116, the balance management system 106 generates an initial iteration of the machine learning algorithm or artificial intelligence. For instance, the balance management system 106 may initialize a set of coefficients {α1, α2, α3, . . . αn} randomly according to a Gaussian distribution with low variance centered around zero. Using this initial iteration of the machine learning algorithm or artificial intelligence, the balance management system 106 may process the dataset of characteristics of accounts maintained by the payment instrument service 102 and corresponding to different sample users to generate an output. This output may specify, for each sample set of data corresponding to a sample user included in the dataset, an indication of an initial credit limit and correlation function that may be associated with a new secured payment instrument. The balance management system 106 may compare the output generated using the initial iteration of the machine learning algorithm or artificial intelligence to the sample initial credit limits and corresponding correlation functions defined in the dataset for each of the data points (e.g., characteristics of accounts maintained by the payment instrument service 102 and corresponding to different sample users, etc.) to identify any inaccuracies or other errors.

If the output of the machine learning algorithm or artificial intelligence does not satisfy one or more criteria, the balance management system 106 may iteratively update one or more coefficients of the set of coefficients to generate an updated machine learning algorithm or artificial intelligence. For instance, the one or more criteria may include a threshold for the accuracy of the desired machine learning algorithm or artificial intelligence for assigning different initial credit limits and corresponding correlation functions for secured payment instruments based on the balance data corresponding to user accounts associated with the mobile payment services 112, different users' credit evaluations, and historical data corresponding to these different users associated with the payment instrument service 102. The updated machine learning algorithm or artificial intelligence may be used to process the aforementioned training dataset, as well as any additional data points or other datasets provided by the payment instrument service 102 to generate a new output for each data point in the training dataset. In some instances, the balance management system 106 may use an optimization algorithm to iteratively update the one or more coefficients of the set of coefficients associated with the machine learning algorithm or artificial intelligence. For instance, the balance management system 106 may use gradient descent to update the logistic coefficients of the machine learning algorithm or artificial intelligence to generate new cutoff values that may be used to classify the data points of the previously evaluated dataset and of any new data points obtained by the balance management system 106. The balance management system 106 may use this updated machine learning algorithm or artificial intelligence to process the available data points and generate a new output. The balance management system 106 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the balance management system 106 implements the machine learning algorithm or artificial intelligence to dynamically, and in real-time, process the balance data corresponding to different user accounts associated with the mobile payment services 112, the different users' credit evaluation, and historical data corresponding to the different users 114 associated with the payment instrument service 102 to assign different initial credit limits and corresponding correlation functions for new secured payment instruments 116 being issued to these different users. In an embodiment, the balance management system 106 uses new credit evaluations associated with different user accounts (e.g., secured payment instruments) to further retrain or otherwise update the machine learning algorithm or artificial intelligence. For instance, as the machine learning algorithm or artificial intelligence produces, in real-time or near real-time, outputs corresponding to different credit limits and corresponding correlation functions for different secured payment instruments, the balance management system 106 or other evaluator of the machine learning algorithm or artificial intelligence may evaluate the output to determine whether the machine learning algorithm or artificial intelligence is generating appropriate credit limits and correlation functions for these different secured payment instruments and dynamically updating these credit limits according to the assigned correlation functions as the updated spending data is received. This evaluation may result in additional annotated data points that may be used to retrain or otherwise update the machine learning algorithm or artificial intelligence in real-time or near real-time. For instance, if a user 114 is able to improve their credit performance as a result of making timely payments to the payment instrument service 102 to reduce any existing balances associated with an issued secured payment instrument 116 and their credit score increases by a measurable amount, the balance management system 106 may update the dataset such that the machine learning algorithm or artificial intelligence is more likely to assign, for similar users, a credit limit that is equal to the available balance associated with user accounts maintained by the mobile payment service 112. Alternatively, if a user 114 is unable to improve their credit performance through maintenance of the secured payment instrument 116, the balance management system 106 may update the dataset such that the machine learning algorithm or artificial intelligence is more likely to assign, for similar users, a credit limit according to a more stringent correlation function applied to the available balance associated with user accounts maintained by the mobile payment service 112. Application of this function may result in a credit limit associated with a secured payment instrument being less than the available balance associated with a user account maintained by the mobile payment service 112. Thus, as transactions are processed in real-time, the machine learning algorithm or artificial intelligence may be dynamically re-trained or otherwise updated to better assign credit limits and corresponding correlation functions to secured payment instruments issued to new users.

In an embodiment, clustering algorithms are trained using sample datasets of characteristics of accounts, users, and/or secured payment instruments to classify accounts, customers, and/or secured payment instruments in order to identify the initial credit limit that may be assigned to a new secured payment instrument based on the balance data corresponding to any user accounts associated with the mobile payment services 112, the user's credit evaluation, and historical data corresponding to the user 114 and other users associated with the payment instrument service 102. Examples of such clustering algorithms may include, but are not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

It should be noted that the balance management system 106, through the machine learning algorithm or artificial intelligence, can continuously and simultaneously process balance data corresponding to different accounts associated with different users, credit evaluations associated with these different users, and historical data corresponding to these different users to assign different credit limits to new secured payment instruments as new applications for these secured payment instruments are received. For instance, as the secured instrument application system 104 receives or otherwise obtains different applications for secured payment instruments from different users, as well as any corresponding account data from the user accounts datastore 110, the secured instrument application system 104 may continuously provide the different applications and corresponding account data to the balance management system 106 for real-time processing. As these different applications and corresponding account data and credit evaluations are received, the machine learning algorithm or artificial intelligence implemented and dynamically trained by the balance management system 106 may continuously and simultaneously process these different applications and corresponding account data and credit evaluations to assign, for each application (i.e., user), an initial credit limit for a new secured payment instrument for the corresponding user. In some instances, the balance management system 106 may be configured with various special-purpose components that can facilitate real-time or near real-time processing of different applications and corresponding account data and credit evaluations as these different applications are received from any number of different users. Further, these various special-purpose components may be configured to automatically and in real-time or near real-time generate a set of initial credit limits for new secured payment instruments through the aforementioned machine learning algorithm or artificial intelligence.

In some instances, while machine learning algorithms or artificial intelligence may be used to determine an initial credit limit for a new secured payment instrument 116 and to determine a function for dynamically adjusting the credit limit according to changes to the available balance corresponding to a user account associated with the mobile payment service 112, the balance management system 106 may determine the initial credit limit and corresponding function using other techniques. For example, the balance management system 106 may automatically allocate, for the new secured payment instrument 116 a credit limit equal to the current available balance corresponding to the user account associated with the mobile payment service 112. Further, as described in greater detail herein, the balance management system 106 may maintain a 1:1 correlation between the credit limit associated with the secured payment instrument 116 and the available balance corresponding to the user account associated with the mobile payment service 112. For example, if the available balance corresponding to the user account associated with the mobile payment service 112 is reduced by $100 based on a new transaction associated with the user account, the balance management system 106 may automatically, and in real-time, reduce the credit limit associated with the secured payment instrument 116 by $100.

In an embodiment, the balance management system 106 provides the amount of the line of credit for the secured payment instrument 116 to the secured instrument application system 104. In response, the secured instrument application system 104 may provide the user 114 with information corresponding to the amount of the line of credit and the corresponding user account associated with the mobile payment service 112 that is to be used to secure the secured payment instrument 116. For instance, if the user 114 submitted their application for a new secured payment instrument 116 through an application or web portal provided by the payment instrument service 102, the secured instrument application system 104 may update a user interface (such as a graphical user interface (GUI)) associated with the application or web portal to present the amount of the line of credit, the corresponding user account associated with the mobile payment service 112 that is to be used to secure the secured payment instrument 116, and any other information associated with the secured payment instrument 116 (e.g., terms and conditions, interest rates, re-payment schedules, etc.).

Once the user 114 has agreed to the terms and conditions, as well as to the line of credit, the secured instrument application system 104 may issue the secured payment instrument 116 to the user 114. As noted above, this secured payment instrument 116 may be secured using the available balance from the user account associated with the mobile payment service 112. However, the user 114 may not be required to hold any amount from other financial accounts in escrow to serve as a deposit for the secured payment instrument 116. Thus, the user 114 may have additional flexibility with regard to their other financial accounts while being subject to the available balance corresponding to the user account maintained by the mobile payment service 112 and associated with the secured payment instrument 116.

In an embodiment, the balance management system 106 monitors, in real-time, balance data corresponding to the user account associated with the mobile payment service 112 as transactions occur in order to determine whether to update the credit limit associated with the secured payment instrument 116. For instance, the balance management system 106 may continuously, and in real-time, obtain a stream of data from the mobile payment service 112 corresponding to different user accounts maintained by the mobile payment service 112 and that may be linked to issued secured payment instruments 116. This stream of data may include balance data corresponding to the user account, which may represent any real-time changes to the available balance associated with the user account as transactions involving the user account occur. In an embodiment, the balance management system 106 processes the obtained balance data to determine whether there has been a change in the available balance corresponding to the user account associated with the mobile payment service 112. Based on any identified changes to the available balance corresponding to the user account associated with the mobile payment service 112, the balance management system 106 may determine whether to dynamically update the credit limit associated with the secured payment instrument 116.

As an illustrative example, if the amount of the credit limit associated with the secured payment instrument 116 is $1,000 based on an initial available balance corresponding to the user account associated with the mobile payment service 112, and the balance management system 106 determines that the available balance has decreased from the initial available balance of $1,000 to $900, the balance management system 106 may dynamically, and in real-time, reduce the credit limit to $900. Thus, the balance management system 106 may maintain a 1:1 correlation between the credit limit associated with the secured payment instrument 116 and the available balance corresponding to the user account associated with the mobile payment service 112.

In an embodiment, if the amount of the credit limit associated with the secured payment instrument 116 is initially set as a function of the initial available balance corresponding to the user account associated with the mobile payment service 112, the reduction in the amount of the credit limit may be determined based on this function. As an illustrative example, if the amount of the credit limit associated with the secured payment instrument 116 is $1,000 based on an initial available balance corresponding to the user account associated with the mobile payment service 112 of $2,000, and the balance management system 106 determines that the available balance has decreased from the initial available balance of $2,000 to $1,900, the balance management system 106 may dynamically, and in real-time, reduce the credit limit to $950 based on the function used to determine the available credit limit for the secured payment instrument 116.

In some instances, while an identified function may be used to determine the initial credit limit associated with the secured payment instrument 116, the balance management system 106 may maintain a 1:1 correlation between changes to the available balance corresponding to the user account associated with the mobile payment service 112 and the credit limit associated with the secured payment instrument 116. As an illustrative example, if the amount of the credit limit associated with the secured payment instrument 116 is $1,000 based on an initial available balance corresponding to the user account associated with the mobile payment service 112 of $2,000, and the balance management system 106 determines that the available balance has decreased from the initial available balance of $2,000 to $1,900, the balance management system 106 may dynamically, and in real-time, reduce the credit limit to $900. Thus, even though the initial credit limit associated with the secured payment instrument 116 is determined as a function of the available balance corresponding to the user account associated with the mobile payment service 112, any subsequent changes to the available balance may result in a 1:1 change to the credit limit (e.g., $100 reduction to the available balance results in a $100 reduction in the credit limit associated with the secured payment instrument 116).

In an embodiment, if the balance management system 106 determines, based on the obtained balance data, that the available balance corresponding to the user account associated with the mobile payment service 112 has increased beyond the initial available balance used to determine the credit limit associated with the secured payment instrument 116, the balance management system 106 may dynamically and in real-time determine whether to increase the credit limit associated with the secured payment instrument 116. For example, if the balance management system 106 determines, based on obtained balance data from the mobile payment service 112, that the available balance associated with the user account has increased beyond the initial available balance used to determine the credit limit associated with the secured payment instrument 116, the balance management system 106 may automatically, and in real-time, increase the credit limit associated with the secured payment instrument 116 in proportion to the increase in the available balance beyond the initial available balance used to determine the initial credit limit associated with the secured payment instrument 116. Alternatively, the balance management system 106 may maintain the initial credit limit regardless of the increase in the available balance beyond the initial available balance used to determine the initial credit limit associated with the secured payment instrument 116.

In some instances, if the balance management system 106 determines, based on the obtained balance data, that the available balance corresponding to the user account associated with the mobile payment service 112 has increased beyond the initial available balance used to determine the credit limit associated with the secured payment instrument 116, the balance management system 106 may obtain a new credit evaluation associated with the user 114 to determine whether the credit limit associated with the secured payment instrument 116 may be increased in proportion to the increase in the available balance. For instance, the balance management system may submit a new credit inquiry to a credit reporting service to obtain a new credit evaluation for the user 114. Based on this new credit evaluation, the balance management system 106 may determine whether the credit limit associated with the secured payment instrument 116 may be increased beyond the initial credit limit allocated to the secured payment instrument 116 and in proportion to the increase of the available balance corresponding to the user account associated with the mobile payment service 112. For instance, if the balance management system 106 determines, based on the new credit evaluation, that the user's credit performance has improved by a measurable amount (e.g., the user's credit score(s) have increased, the user's ability to make timely payments has improved over time, etc.), the balance management system 106 may determine that the credit limit associated with the secured payment instrument 116 may be increased according to the increase in the available balance corresponding to the user account associated with the mobile payment service 112. Alternatively, if there has been no improvement in the user's credit performance, the balance management system 106 may maintain the same credit limit for the secured payment instrument 116 regardless of the increase to the available balance corresponding to the user account associated with the mobile payment service 112.

In an embodiment, in addition to dynamically adjusting the credit limit associated with the secured payment instrument 116 based on obtained balance data from the mobile payment services 112, the balance management system 106 may obtain transaction data associated with the secured payment instrument 116 from a transaction processing system 108. The transaction processing system 108 may be implemented using a computer system of the payment instrument service 102. In some instances, the transaction processing system 108 may be implemented as an application or executable process that is executed on a computer system of the payment instrument service 102. The transaction processing system 108 may, in real-time, process transactions associated with the secured payment instrument 116. For instance, when a user 114 utilizes their secured payment instrument 116 at a point-of-sale or through an online merchant, the transaction processing system 108 may process a transaction corresponding to use of the secured payment instrument 116 by ensuring that the account associated with the secured payment instrument 116 may be used for the particular transaction. For example, if the user 114 utilizes their secured payment instrument 116 at a point-of-sale to purchase groceries, the transaction processing system 108 may determine whether the amount required for the purchase of these groceries is available from the account associated with the secured payment instrument 116. If the required amount is not available (e.g., applying the required amount to the account would exceed the credit limit), the transaction processing system 108 may automatically decline the transaction. Alternatively, if the transaction processing system 108 determines that the transaction may be processed (e.g., applying the required amount to the account would not exceed the credit limit), the transaction processing system 108 may automatically approve the transaction, provide payment to the corresponding merchant, and deduct the amount from the available line of credit associated with the secured payment instrument 116.

In an embodiment, the balance management system 106 transmits transaction data associated with the secured payment instrument 116 in real-time to the mobile payment service 112. The transaction data may be transmitted with identifying information associated with the user 114 (e.g., username(s), token(s), etc.) that may be used by the mobile payment service 112 to identify the user account associated with the user 114. In response to obtaining the transaction data, the mobile payment service 112 may dynamically, and in real-time, adjust the available balance associated with the user account such that the available balance is reduced according to the amount associated with the transactions completed using the secured payment instrument 116. For example, if the secured payment instrument 116 is used for transactions totaling $60, the mobile payment service 112 may reduce the available balance associated with the user account maintained by the mobile payment service 112 by $60. While the user account maintained by the mobile payment service 112 may still have the full amount absent the transaction data, the mobile payment service 112 may hold the transaction amount in abeyance until the user 114 pays off this amount from the account associated with the secured payment instrument 116. Thus, any existing balances associated with the secured payment instrument 116 may be securitized using an amount from the available balance associated with the user account maintained by the mobile payment service 112. This may ensure that if the user 114 defaults on payment of an existing balance from the secured payment instrument 116, the balance management system 106 may obtain the amount of this existing balance from the user account maintained by the mobile payment service 112. As the user 114 reduces their existing balance from the secured payment instrument 116, a portion of the available balance held in abeyance by the mobile payment service 112 equal to this reduction to their existing balance may be released for use.

Any amounts held in abeyance from the available balance associated with the user account maintained by the mobile payment service 112, in some instances, may not be used to reduce the credit limit associated with the secured payment instrument 116. For instance, since real-time transactions associated with the secured payment instrument 116 may reduce the amount of the line of credit available to the user 114 at any given time, there may be no need to adjust the credit limit associated with the secured payment instrument 116, as the amount corresponding to these transactions is automatically deducted from the available balance associated with the user account maintained by the mobile payment service 112 and held in abeyance as security for these transactions. However, if the user 114 utilizes any of the remaining available amount from the user account maintained by the mobile payment service 112, the balance management system 106 may automatically reduce the credit limit associated with the secured payment instrument 116 according to the amount utilized from the remaining available amount, as described above.

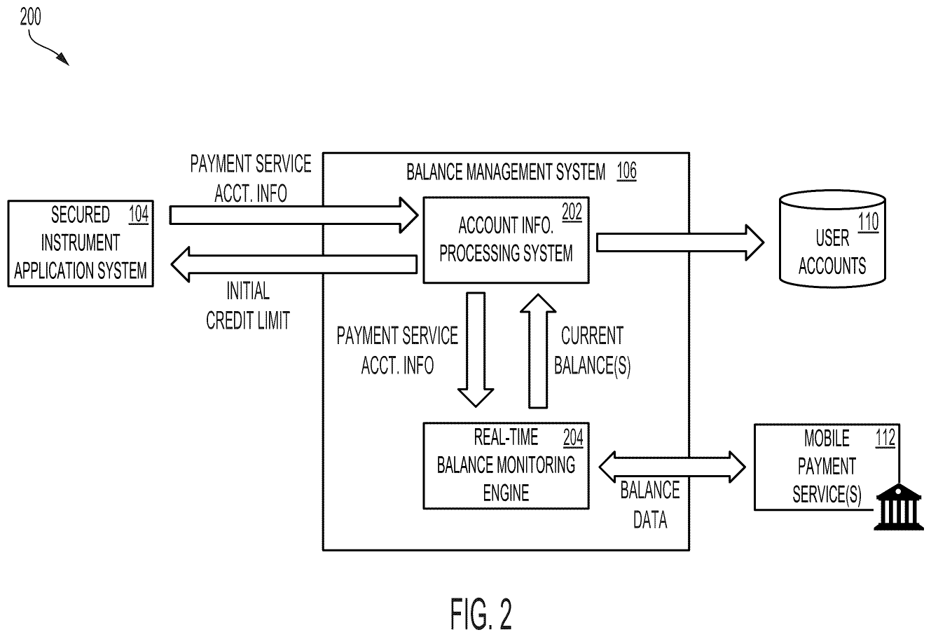

FIG. 2 shows an illustrative example of an environment 200 in which a balance management system 106 dynamically determines an initial credit limit associated with a secured payment instrument based on available balances corresponding to user accounts associated with one or more mobile payment services 112 in accordance with at least one embodiment. In the environment 200, the secured instrument application system 104 may provide an application or other request for a new line of credit associated with a secured payment instrument to an account information processing system 202 of the balance management system 106. The application or other request may include user information associated with a user applying for the new line of credit. This user information may include information corresponding to one or more accounts associated with one or more mobile payment services 112, such as account credentials (e.g., usernames, passwords, cryptographic tokens, account numbers, routing numbers, etc.) that may be used to access these one or more accounts. Further, the user information may include information that may be used to perform a credit inquiry of the user's credit report to determine whether the user is qualified for a new line of credit associated with a secured payment instrument. For instance, user information may include the user's legal name, birthdate, last four digits of their Social Security number, household income, and the like. In some instances, if the user is associated with an existing account associated with the payment instrument service, the user information may include user credentials or identifiers corresponding to the existing account (e.g., username, passwords, cryptographic tokens, etc.).

In response to receiving the application or other request, including the user information, the account information processing system 202 may submit a request to a credit reporting service to perform a credit inquiry of the user's credit report. The credit reporting service, in response to the credit inquiry, may provide the account information processing system 202 with data that may be used to determine the user's credit performance over time. This data, for instance, may include one or more credit scores associated with the user, the current amount of credit allocated to the user from different financial entities (including the payment instrument service, if any), the current amount of credit available to the user, the user's credit repayment history, any known delinquencies, and the like.

In an embodiment, the account information processing system 202 further provides the obtained user information to a real-time balance monitoring engine 204. The real-time balance monitoring engine 204, in response to obtaining this user information, may access one or more accounts associated with the user and maintained by one or more mobile payment services 112. As noted above, a mobile payment service 112 may include a P2P payment platform through which users may make payments to other peers and receive payments from other peers through different transactions within the P2P payment platform. Amounts received from other peers or added to the user account through one or more accounts associated with other financial institutions (e.g., bank account, credit union account, etc.) may be represented as a balance associated with the user account. The user may leverage this available balance for payments to other entities associated with the mobile payment service 112 or transfer to a linked account (e.g., bank account, credit union account, etc.).

The real-time balance monitoring engine 204 may automatically access an account associated with the user and maintained by a mobile payment service 112 by using a corresponding set of credentials provided by the user through their application or other request, or as identified from a user account associated with the payment instrument service (e.g., from the user accounts datastore 110). In some examples, to automatically access an account maintained by a mobile payment service 112, the real-time balance monitoring engine 204 may transmit an API call to a computer system of the mobile payment service 112. This API call may include the requisite credentials (as provided through the application/request or obtained from the user accounts datastore 110) needed to access the account associated with the user. The mobile payment service 112 may authenticate the provided set of credentials and, if valid, determine whether the user has provided the requisite authorization for the real-time balance monitoring engine 204 to access the account.

From an account associated with a user and maintained by a mobile payment service 112, the real-time balance monitoring engine 204 may automatically obtain balance data associated with the user account maintained by the mobile payment service 112. The balance data may specify the current available balance associated with the user account maintained by the mobile payment service 112. In some instances, the balance data may further specify any fluctuations to the available balance associated with the user account over a particular period of time (e.g., past six months, past year, past three years, etc.). As noted above, these fluctuations to the available balance associated with the user account over the particular period of time may be used to determine an average balance associated with the user account over time.

In some instances, the real-time balance monitoring engine 204 may continuously, and in real-time, obtain a stream of data from the mobile payment service 112 corresponding to different user accounts maintained by the mobile payment service 112 and that may be linked to issued secured payment instruments 116. This stream of data may include balance data corresponding to the user account, which may represent any real-time changes to the available balance associated with the user account as transactions involving the user account maintained by the mobile payment service 112 occur. Thus, while the real-time balance monitoring engine 204 may obtain an initial stream of balance data that may be used as described herein to determine an initial credit limit for the new secured payment instrument, the real-time balance monitoring engine 204 may continue to process balance data from the mobile payment service 112 for use in dynamically updating the credit limit associated with the new secured payment instrument in real-time as transactions involving the user account maintained by the mobile payment service 112 occur.

In an embodiment, the real-time balance monitoring engine 204 provides, in real-time, the balance data obtained from the mobile payment service 112 to the account information processing system 202. In response to obtaining this balance data associated with the user account maintained by the mobile payment service 112, the account information processing system 202 may process this balance data to determine an initial credit limit for the secured payment instrument that is to be issued to the user. For instance, the account information processing system 202 may automatically allocate, for the new secured payment instrument, a credit limit equal to the current available balance corresponding to the user account associated with the mobile payment service 112. Further, based on the credit evaluation associated with the user and the obtained balance data, the account information processing system 202 may determine a function that may be used to dynamically, and in real-time, adjust the credit limit associated with the secured payment instrument as the available balance associated with the user account maintained by the mobile payment service 112 fluctuates over time. As an illustrative example, if the account information processing system 202 defines a 1:1 correlation function for the credit limit associated with the secured payment instrument, the account information processing system 202 may dynamically, and in real-time, adjust the credit limit associated with the secured payment instrument by the same amount as the change to the available balance associated with the user account maintained by the mobile payment service 112. For example, if the available balance corresponding to the user account maintained by the mobile payment service 112 is reduced by $100 based on a new transaction associated with the user account, the account information processing system 202 may automatically, and in real-time, reduce the credit limit associated with the secured payment instrument by $100.

Other correlation functions are contemplated, whereby the credit limit associated with a secured payment instrument may be reduced at a greater rate (e.g., 2:1, 3:1, 4:1, etc.) if the available balance associated with a user account maintained by the mobile payment service 112 is reduced. For example, if the available balance associated with a user account maintained by the mobile payment service 112 is reduced from $1,000 to $900, and the account information processing system 202 has defined a 2:1 correlation function for the credit limit, the account information processing system 202 may automatically reduce the credit limit associated with the secured payment instrument from $1,000 to $800. As noted above, the correlation function that may be defined for a particular secured payment instrument may be determined based on the credit evaluation performed by the account information processing system 202 and the obtained balance data.

As noted above, to determine the initial credit limit for the secured payment instrument and the corresponding correlation function, the account information processing system 202 may dynamically train, in real-time or near real-time, a machine learning algorithm or artificial intelligence to process the balance data corresponding to the user account maintained the mobile payment service 112, the user's credit evaluation, and historical data corresponding to the user and other users associated with the payment instrument service. For example, the account information processing system 202 may dynamically train, in real-time or near real-time, a clustering algorithm to identify, based on one or more vectors of similarity (e.g., credit scores, changes in credit scores, balances corresponding to accounts associated with the mobile payment service 112, changes in balances corresponding to accounts associated with the mobile payment service 112, spending habits, total amount of credit allocated, total amount of credit available, payment performance, demographic information, etc.), similar accounts and/or account holders associated with previously issued secured payment instruments. From these similar accounts and/or account holders identified using the clustering algorithm, the account information processing system 202 may determine an initial credit limit for the new secured payment instrument, as a well as a correlation function that may be used to determine how to dynamically, and in real-time, adjust the credit limit as transactions involving the user account maintained by the mobile payment service 112 occur.

Once the account information processing system 202 has determined an initial credit limit for the secured payment instrument and a corresponding correlation function usable to dynamically adjust the credit limit in real-time, the account information processing system 202 may update an entry corresponding to the new secured payment instrument within the user accounts datastore 110 to indicate the initial credit limit for the new secured payment instrument and the corresponding correlation function. Further, the account information processing system 202 may provide the initial credit limit to the secured instrument application system 104. As noted above, the secured instrument application system 104 may provide the user with information corresponding to the amount of the line of credit (e.g., the initial credit limit) for the secured payment instrument. Further, the secured instrument application system 104 may provide any other information associated with the secured payment instrument (e.g., terms and conditions, interest rates, re-payment schedules, etc.). If the user agrees to the line of credit and the terms and conditions provided by the secured instrument application system 104, the secured instrument application system 104 may issue the secured payment instrument to the user.

It should be noted that the account information processing system 202 and the real-time balance monitoring engine 204 can continuously and simultaneously process user information and balance data corresponding to different users and user accounts as corresponding secured payment instrument applications are submitted by different users. For instance, as the account information processing system 202 receives different applications or other requests for new lines of credit associated with different secured payment instruments, the account information processing system 202 may dynamically, in real-time or near real-time and for any number of received applications or other requests, perform credit inquiries corresponding to the different users associated with these different application or other requests. Further, the account information processing system 202 may dynamically, in real-time or near real-time and for any number of received applications or other requests, provide the results of these credit inquiries and any user information obtained through these received application or other requests to the real-time balance monitoring engine 204. In an embodiment, the real-time balance monitoring engine 204 further continuously and simultaneously processes any user information obtained from the account information processing system 202 and any balance data obtained from any number of different mobile payment services 112 to dynamically assign initial credit limits for different secured payment instruments. Additionally, the real-time balance monitoring engine 204 may continuously and simultaneously process balance data from different mobile payment services 112 and associated with different secured payment instruments in real-time or near real-time to dynamically adjust any credit limits associated with these different secured payment instruments, as described in greater detail herein.

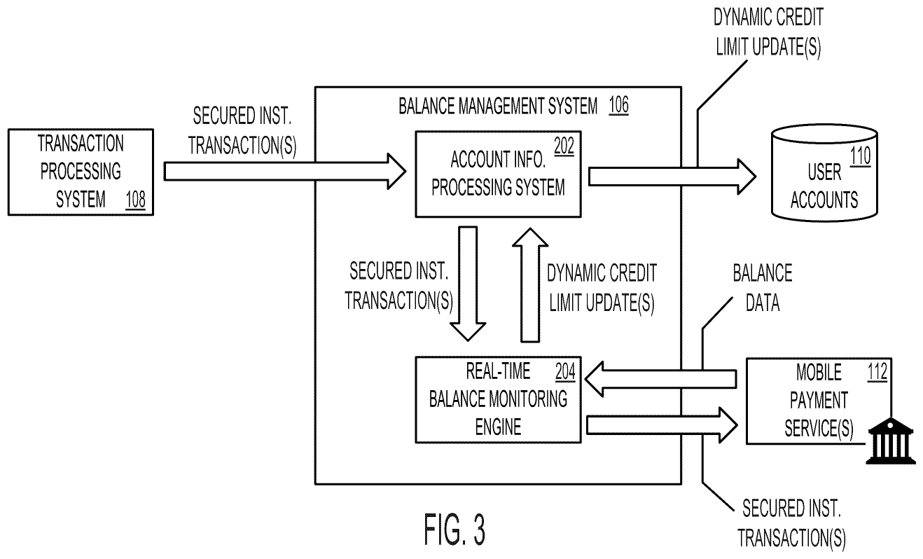

FIG. 3 shows an illustrative example of an environment 300 in which a balance management system 106 dynamically adjusts a credit limit associated with a secured payment instrument and available balances corresponding to user accounts associated with one or more mobile payment services 112 as transactions are processed in real-time in accordance with at least one embodiment. In the environment 300, the real-time balance monitoring engine 204 of the balance management system 106 may continuously, and in real-time, obtain balance data from the mobile payment service 112 for different user accounts associated with the mobile payment service 112. As noted above, the real-time balance data from the mobile payment service 112 may indicate the current available balance for different user accounts associated with the mobile payment service 112 at any given time. When a transaction involving a user account associated with mobile payment service 112 is processed, resulting in a change to the current available balance for the user account, the mobile payment service 112 may provide, in real-time and through the real-time balance data, this change to the current available balance. Thus, as transactions are processed by the mobile payment service 112 for different user accounts, the mobile payment service 112 may automatically, and in real-time, provide updated balance data.

In an embodiment, the real-time balance monitoring engine 204 automatically processes the obtained real-time balance data from the mobile payment service 112 to determine whether an adjustment of a credit limit associated with a secured payment instrument is required. For example, in response to obtaining new real-time balance data, the real-time balance monitoring engine 204 may automatically query the user accounts datastore 110 to determine, for each secured payment instrument, a current credit limit associated with the secured payment instrument. As noted above, the initial credit limit associated with a secured payment instrument may be determined based on the available balance associated with a corresponding user account maintained by the mobile payment service 112 at the time of issuance of the secured payment instrument. Further, when issuing the secured payment instrument, the account information processing system 202 may define a function that may be used to calculate the credit limit associated with the secured payment instrument over time based on fluctuations to the available balance associated with the user account maintained by the mobile payment service 112. Accordingly, the real-time balance monitoring engine 204 may further obtain, from the user accounts datastore 110, the defined function, the previous available balance associated with the user account maintained by the mobile payment service 112, and the initial credit limit assigned to the particular secured payment instrument being reviewed.

In an embodiment, the real-time balance monitoring engine 204 automatically processes the balance data from the mobile payment service 112, the current credit limit associated with the secured payment instrument, the initial credit limit associated with the secured payment instrument, and the correlation function to define a new credit limit for the secured payment instrument. As an illustrative example, assume that the initial credit limit associated with the secured payment instrument is $1,000 and the current credit limit associated with the secured payment instrument is $900. Further, the available balance associated with a corresponding user account maintained by the mobile payment service 112 is reduced from $900 to $800. If the defined correlation function corresponds to a 1:1 correlation between the credit limit associated with the secured payment instrument and the available balance associated with the corresponding user account maintained by the mobile payment service 112, the real-time balance monitoring engine 204 may dynamically, and in real-time, reduce the credit limit associated with the secured payment instrument from $900 to $800 in order to match the available balance associated with the corresponding user account maintained by the mobile payment service 112.

As another illustrative example of the dynamic adjustment to a credit limit associated with a secured payment instrument, again assume that the initial credit limit associated with the secured payment instrument is $1,000 and the current credit limit associated with the secured payment instrument is $900. Further, the available balance associated with a corresponding user account maintained by the mobile payment service 112 is reduced from $950 to $850. If the defined correlation function corresponds to a 2:1 correlation between the credit limit associated with the secured payment instrument and the available balance associated with the corresponding user account maintained by the mobile payment service 112, the real-time balance monitoring engine 204 may dynamically, and in real-time, reduce the credit limit associated with the secured payment instrument from $900 to $700 in order to maintain the defined correlation between the credit limit associated with the secured payment instrument and the available balance associated with the corresponding user account maintained by the mobile payment service 112.

In some instances, the real-time balance data may be indicative of an increase in the available balance associated with a user account maintained by the mobile payment service 112. Accordingly, the real-time balance monitoring engine 204 may determine whether the new available balance associated with the user account is greater than the initial credit limit associated with the secured payment instrument. If the real-time balance monitoring engine 204 determines that the available balance associated with the user account is greater than the initial credit limit associated with the secured payment instrument, the real-time balance monitoring engine 204 may determine whether the credit limit may be increased beyond the initial credit limit associated with the secured payment instrument. For instance, the real-time balance monitoring engine 204 may obtain a new credit evaluation associated with the user to determine whether the credit limit associated with the secured payment instrument may be increased according to the correlation function defined for the secured payment instrument. Based on this credit evaluation, the real-time balance monitoring engine 204 may determine whether the credit limit may be increased beyond the initial credit limit associated with the secured payment instrument according to the correlation function. For example, if the initial credit limit associated with the secured payment instrument is $1,000, the available balance associated with a user account maintained by the mobile payment service 112 has increased to $1,200, and the secured payment instrument is assigned a 1:1 correlation function, the real-time balance monitoring engine 204 may increase the credit limit associated with the secured payment instrument from $1,000 to $1,200.

It should be noted that the credit limit associated with the secured payment instrument may be capped according to the current available balance associated with the user account maintained by the mobile payment service 112. Returning to the previous example, where the initial credit limit associated with the secured payment instrument is $1,000 and the available balance associated with a user account maintained by the mobile payment service 112 has increased to $1,200, if the secured payment instrument is assigned a 2:1 correlation function, the real-time balance monitoring engine 204 would not increase the credit limit associated with the secured payment instrument from $1,000 to $1,400, as this would exceed the available balance associated with a user account maintained by the mobile payment service 112. Instead, the credit limit associated with the secured payment instrument may be increased to the current available balance of $1,200. Further, the real-time balance monitoring engine 204 may update the user accounts datastore 110 to indicate that fluctuations to the available balance associated with the user account maintained by the mobile payment service 112 may not impact the credit limit unless the available balance falls below $1,200.

If the real-time balance monitoring engine 204 determines, based on the new credit evaluation, that the credit limit associated with the secured payment instrument may not be increased beyond the initial credit limit, the real-time balance monitoring engine 204 may maintain the initial credit limit regardless of how much the available balance associated with the user account maintained by the mobile payment service 112 exceeds this initial credit limit. Additionally, the real-time balance monitoring engine 204 may update the user accounts datastore 110 to indicate that fluctuations to the available balance associated with the user account maintained by the mobile payment service 112 may not impact the credit limit unless the available balance falls below the initial credit limit. Thus, as fluctuations to the available balance associated with the user account maintained by the mobile payment service 112 occur, the real-time balance monitoring engine 204 may dynamically, and in real-time, update the credit limit associated with the secured payment instrument subject to current credit evaluations and identified correlation functions.

In an embodiment, the real-time balance monitoring engine 204 may provide any dynamic credit limit updates associated with a secured payment instrument to the account information processing system 202. The account information processing system 202 may, in real-time, update the user accounts datastore 110 to indicate the new credit limit associated with the secured payment instrument. This may allow a user associated with the secured payment instrument to monitor, in real-time, any changes to their credit limit associated with the secured payment instrument. Further, this allows the transaction processing system 108 to determine whether to approve or deny any pending transactions for which the secured payment instrument has been used.

As noted above, in addition to dynamically adjusting the credit limit associated with the secured payment instrument based on obtained real-time balance data from the mobile payment service 112, the balance management system 106 may obtain transaction data associated with the secured payment instrument from a transaction processing system 108. The transaction data may be obtained by the account information processing system 202, in real-time, as transactions associated with the secured payment instrument occur. In response to obtaining this transaction data, the account information processing system 202 may provide the transaction data to the real-time balance monitoring engine 204 in real-time. Further, the real-time balance monitoring engine 204 may transmit the transaction data obtained from the account information processing system 202, in real-time, to the mobile payment service 112.

In response to obtaining the transaction data, the mobile payment service 112 may dynamically, and in real-time, adjust the available balance associated with the user account such that the available balance is reduced according to the amount associated with the transactions completed using the secured payment instrument. For example, if the secured payment instrument is used for transactions totaling $60, the mobile payment service 112 may automatically reduce, in real-time, the available balance associated with the user account maintained by the mobile payment service 112 by $60. While the user account maintained by the mobile payment service 112 may still maintain the full amount for the user account, the mobile payment service 112 may hold the transaction amount in abeyance until the user pays off this amount from the secured payment instrument. Thus, any existing balances associated with the secured payment instrument may be securitized using an amount from the available balance associated with the user account maintained by the mobile payment service 112. This may ensure that if the user defaults on payment of an existing balance associated with the secured payment instrument, the real-time balance monitoring engine 204 may obtain the amount corresponding to the existing balance from the user account maintained by the mobile payment service 112.

As the user reduces their existing balance associated with the secured payment instrument, a portion of the available balance held in abeyance by the mobile payment service 112 equal to this reduction to their existing balance may be released for use. For example, if the user has an initial balance associated with the secured payment instrument of $60, and the user submits a payment to the payment instrument service to reduce this balance from $60 to $30, the real-time balance monitoring engine 204 may transmit, in real-time, this update to the secured payment instrument to the mobile payment service 112. Accordingly, the mobile payment service 112 may increase the amount that is available to the user from the available balance associated with the account by $30.

As noted above, any amounts held in abeyance from the available balance associated with the user account maintained by the mobile payment service 112 may not be used to reduce the credit limit associated with the secured payment instrument. For instance, since real-time transactions associated with the secured payment instrument may reduce the amount of the line of credit available to the user at any given time, there may be no need to adjust the credit limit associated with the secured payment instrument, as the amount corresponding to these transactions is automatically deducted from the available balance associated with the user account maintained by the mobile payment service 112 and held in abeyance as security for these transactions. However, if the user utilizes any of the remaining available amount from the user account maintained by the mobile payment service 112, the real-time balance monitoring engine 204 may automatically reduce the credit limit associated with the secured payment instrument according to the amount utilized from the remaining available amount, as described above.

In an embodiment, the real-time balance monitoring engine 204 dynamically and in real-time updates the dataset used by the aforementioned machine learning or artificial intelligence to determine initial credit limits for different secured payment instruments issued to users associated with the payment instrument service. These updates to the dataset may be performed as the account associated with the secured payment instrument and the available balance associated with the user account maintained by the mobile payment service 112 are dynamically updated in real-time based on transactions corresponding to usage of the secured payment instrument and the user account maintained by the mobile payment service 112. For instance, if the user is able to improve their credit performance as a result of making timely payments to the payment instrument service to reduce any existing balances associated with the secured payment instrument, the real-time balance monitoring engine 204 may update the dataset such that the account information processing system 202 is more likely to assign, for similar users, an initial credit limit that is equal to the available balance associated with user accounts maintained by the mobile payment service 112. Alternatively, if the user is unable to improve their credit performance through maintenance of the secured payment instrument, the real-time balance monitoring engine 204 may update the dataset such that the account information processing system 202 is more likely to assign, for similar users, an initial credit limit and a corresponding correlation function that may be applied to the available balance associated with user accounts maintained by the mobile payment service 112. Application of this correlation function may result in a credit limit associated with a secured payment instrument being less than the available balance associated with a user account maintained by the mobile payment service 112. Thus, as transactions are processed in real-time, the machine learning algorithm or artificial intelligence may be dynamically re-trained or otherwise updated in real-time to better assign credit limits to secured payment instruments issued to new users.

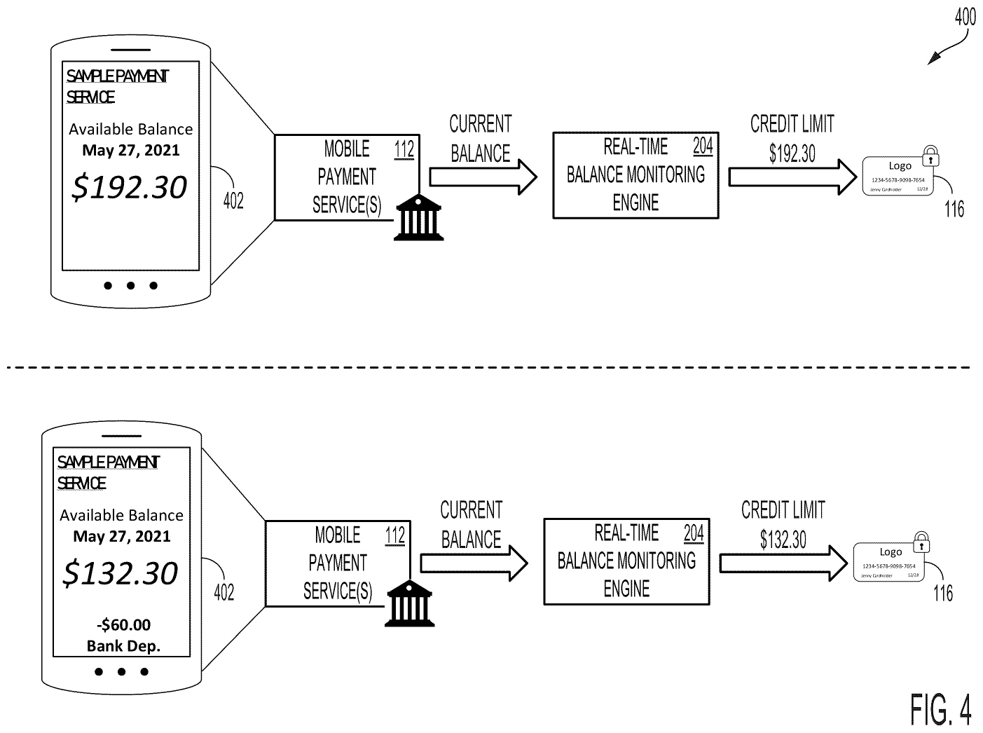

FIG. 4 shows an illustrative example of an environment 400 in which a real-time balance monitoring engine 204 dynamically adjusts an available credit limit associated with a secured payment instrument 116 in real-time based on transactions corresponding to a user account associated with a mobile payment service 112 in accordance with at least one embodiment. As noted above, the real-time balance monitoring engine 204 may obtain, in real-time, balance data from the mobile payment service 112. This balance data from the mobile payment service 112 may indicate the current available balance for different user accounts associated with the mobile payment service 112 at any given time. For instance, as illustrated in FIG. 4, the mobile payment service 112 may automatically transmit, in real-time, balance data that indicates that the current balance associated with a user account maintained by the mobile payment service 112 is $192.30. This available balance may be presented to the user via an application provided by the mobile payment service 112 and implemented on a user device 402. Thus, the user may readily determine their available balance associated with their user account maintained by the mobile payment service 112.

In response to obtaining the real-time balance data from the mobile payment service 112, the real-time balance monitoring engine 204 may process this real-time balance data to determine that the current balance for the user account maintained by the mobile payment service 112 is $192.30. As noted above, the real-time balance monitoring engine 204 may automatically process the obtained real-time balance data from the mobile payment service 112 to determine whether an adjustment to a credit limit associated with a secured payment instrument is required. For instance, the real-time balance monitoring engine 204 may obtain the current credit limit associated with the secured payment instrument 116, the defined correlation function for determining the credit limit at any time based on the current available balance associated with a user account maintained by the mobile payment service 112, the previous available balance associated with the user account maintained by the mobile payment service 112, and the initial credit limit assigned to the secured payment instrument 116. Referring to the example illustrated in FIG. 4, the first balance of $192.30 may be the initial balance that was used to determine the initial credit limit for the secured payment instrument 116. Thus, the first credit limit assigned to the secured payment instrument 116 may also be $192.30.

It should be noted that the first balance of $192.30, as illustrated in FIG. 4, may alternatively correspond to an example where a defined correlation function for determining the credit limit associated with the secured payment instrument 116 corresponds to a 1:1 correlation between the credit limit and the available balance associated with the user account maintained by the mobile payment service 112. Thus, the first balance of $192.30 may not be the initial balance used to determine the initial credit limit for the secured payment instrument 116 but rather the available balance at a particular moment in time for which the credit limit associated with the secured payment instrument 116 was determined by the real-time balance monitoring engine 204 using the defined correlation function.

As illustrated in FIG. 4, at a later time, a user may transfer $60 from their user account maintained by the mobile payment service 112 to their bank account or other account associated with another financial institution. Accordingly, the available balance associated with the user account maintained by the mobile payment service 112 may be reduced from a first balance of $192.30 to a second balance of $132.30, reflecting the withdrawal from the user account. This update to the available balance associated with the user account maintained by the mobile payment service 112 may be reflected in the real-time balance data provided to the real-time balance monitoring engine 204.

In response to obtaining the new real-time balance data from the mobile payment service 112, the real-time balance monitoring engine 204 may again refer to the user accounts datastore maintained by the payment instrument service to obtain the current credit limit associated with the secured payment instrument 116 (e.g., $192.30), the defined correlation function for determining the credit limit at any time based on the current available balance associated with a user account maintained by the mobile payment service 112 (e.g., the aforementioned 1:1 correlation), the previous available balance associated with the user account maintained by the mobile payment service 112 (e.g., $192.30), and the initial credit limit assigned to the secured payment instrument 116. Based on the new real-time balance data from the mobile payment service 112 and the information obtained from the user accounts datastore, the real-time balance monitoring engine 204 may determine that the credit limit associated with the secured payment instrument 116 is to be reduced, according to the correlation function, from a previous value of $192.30 to a new value of $132.30. This may ensure that the secured payment instrument 116, at all times, is fully secured according to the current available balance associated with the user account maintained by the mobile payment service 112.

As noted above, if the available balance associated with the user account maintained by the mobile payment service 112 has increased (e.g., the user has received a deposit from another user to their user account, the user has added funds to the user account, etc.), the real-time balance monitoring engine 204 may determine whether the new available balance associated with the user account is greater than the initial credit limit associated with the secured payment instrument 116. If the real-time balance monitoring engine 204 determines that the available balance associated with the user account is greater than the initial credit limit associated with the secured payment instrument 116, the real-time balance monitoring engine 204 may determine whether the credit limit may be increased beyond the initial credit limit associated with the secured payment instrument. This determination may be made based on a new credit evaluation associated with the user. The credit limit associated with the secured payment instrument may be capped according to the current available balance associated with the user account maintained by the mobile payment service 112 such that, at no point, would the credit limit associated with the secured payment instrument 116 exceed the current available balance associated with the user account maintained by the mobile payment service 112.

In some instances, if the real-time balance monitoring engine 204 determines that the credit limit associated with the secured payment instrument 116 may not be increased beyond the initial credit limit, the real-time balance monitoring engine 204 may maintain the initial credit limit even if the updated available balance associated with the user account maintained by the mobile payment service 112 exceeds this initial credit limit. Further, the real-time balance monitoring engine 204 may maintain this credit limit unless the available balance falls below the initial credit limit. Thus, as fluctuations to the available balance associated with the user account maintained by the mobile payment service 112 occur, the real-time balance monitoring engine 204 may dynamically, and in real-time, update the credit limit associated with the secured payment instrument 116 subject to current credit evaluations for the user and the correlation functions associated with the secured payment instrument 116.

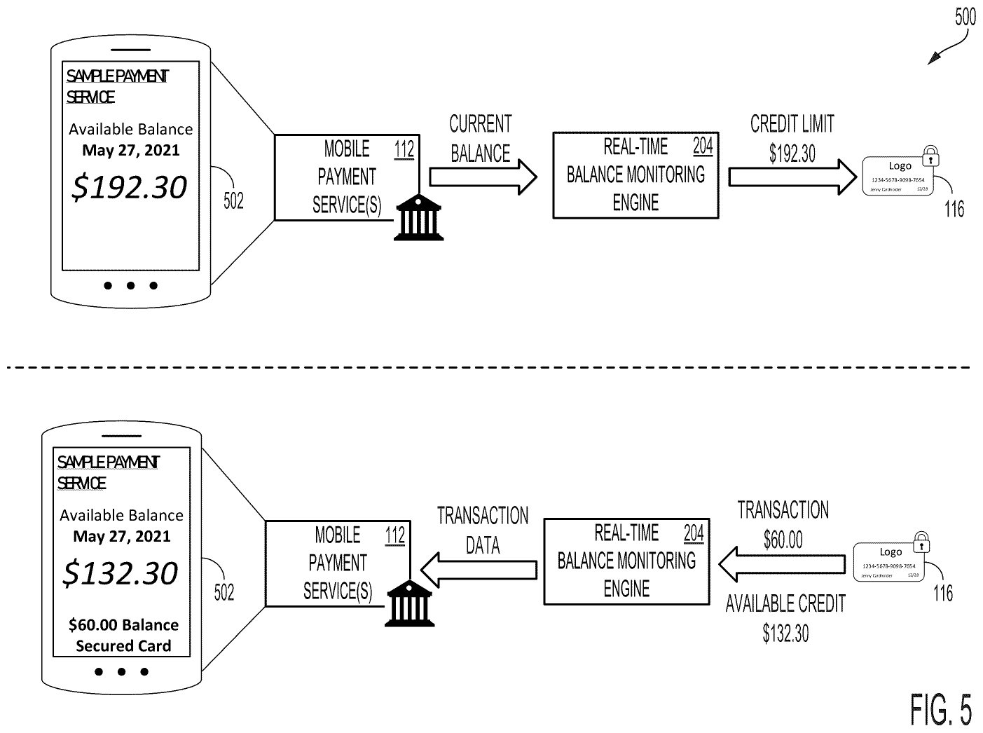

FIG. 5 shows an illustrative example of an environment 500 in which a real-time balance monitoring engine 204 transmits in real-time transaction data associated with a secured payment instrument 116 to cause a mobile payment service 112 to reduce an available balance associated with a user account according to the transaction data in accordance with at least one embodiment. Similar to the environment 400 described above in connection with FIG. 4, in the environment 500, the mobile payment service 112 may automatically transmit, in real-time, balance data that indicates that the current balance associated with a user account maintained by the mobile payment service 112 is $192.30. This available balance may be presented to the user via an application provided by the mobile payment service 112 and implemented on a user device 502. Thus, the user may readily determine their available balance associated with their user account maintained by the mobile payment service 112. In response to obtaining the real-time balance data from the mobile payment service 112, the real-time balance monitoring engine 204 may process this real-time balance data to determine that the current balance for the user account maintained by the mobile payment service 112 is $192.30.

As noted above, in addition to dynamically adjusting the credit limit associated with the secured payment instrument based on obtained real-time balance data from the mobile payment service 112, the real-time balance monitoring engine 204 may obtain transaction data associated with the secured payment instrument from a transaction processing system of the payment instrument service. The transaction data may be obtained by the real-time balance monitoring engine 204, in real-time, as transactions associated with the secured payment instrument 116 occur. In response to obtaining this transaction data, the real-time balance monitoring engine 204 may transmit the transaction data, in real-time, to the mobile payment service 112. The transaction data may be transmitted with identifying information associated with the user (e.g., username(s), token(s), etc.) that may be used by the mobile payment service 112 to identify the user account associated with the user.

The mobile payment service 112, in response to obtaining the real-time transaction data associated with the secured payment instrument 116 linked to the user account maintained by the mobile payment service 112, may dynamically adjust the available balance associated with the user account such that the available balance is reduced according to the amount associated with the transactions completed using the secured payment instrument 116. For example, as illustrated in FIG. 5, the secured payment instrument 116 has been used for a $60 transaction, such as a transaction at a point-of-sale or otherwise associated with a merchant or other entity. The real-time transaction data transmitted by the real-time balance monitoring engine 204 to the mobile payment service 112 may include information corresponding to this $60 transaction. Accordingly, the mobile payment service 112 may automatically reduce, in real-time, the available balance associated with the user account maintained by the mobile payment service 112 by $60 such that the amount available to the user from their account maintained by the mobile payment service 112 is $132.30. While the account maintained by the mobile payment service 112 may still have an actual balance of $192.30, the mobile payment service 112 may hold $60 from the account in abeyance in order to securitize the $60 transaction associated with the secured payment instrument 116. As illustrated in FIG. 5, the mobile payment service 112 may provide, through the user device 502, an indication of the amount from the user account maintained by the mobile payment service 112 that may be available to the user (e.g., $132.30), as well as indication of the amount being held in abeyance (e.g., “$60.00 Balance Secured Card”). This may allow the user to readily determine what amount from the user account is available to them and any amounts being withheld based on existing balances associated with the secured payment instrument 116.

As noted above, as the user reduces their existing balance associated with the secured payment instrument 116, a portion of the available balance held in abeyance by the mobile payment service 112 equal to this reduction may be made available for use. Using the example illustrated in FIG. 5, if the user has an initial balance associated with the secured payment instrument 116 of $60 as a result of a transaction, and the user submits a payment to the payment instrument service to reduce this balance from $60 to $30, the real-time balance monitoring engine 204 may transmit, in real-time, this update to the secured payment instrument 116 to the mobile payment service 112. Accordingly, the mobile payment service 112 may increase the amount that is available to the user from the available balance associated with the account by $30 (e.g., from $132.30 to $162.30). While the actual available amount associated with the user account maintained by the mobile payment service 112 is $192.30, the remaining $30 balance may be held in abeyance until the remainder of the balance is paid off.

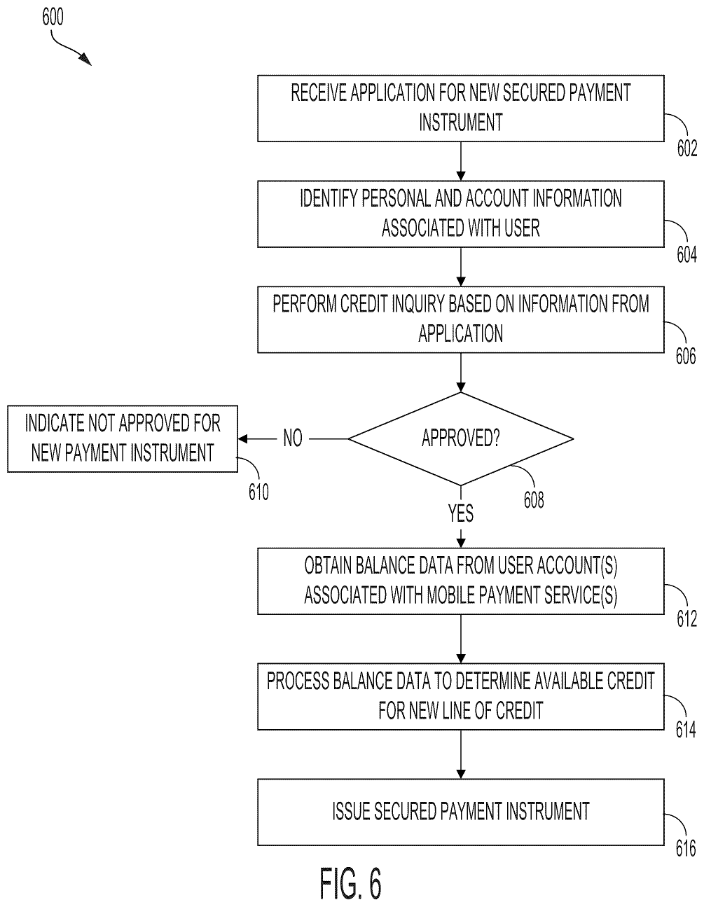

FIG. 6 shows an illustrative example of a process 600 for establishing a secured payment instrument that is secured using available balances corresponding to user accounts associated with one or more mobile payment services in accordance with at least one embodiment. The process 600 may be performed by the payment instrument service, using a secured instrument application system and a balance management system. As noted above, the secured instrument application system is implemented to process incoming applications for secured payment instruments that may be securitized using available balances associated with user accounts maintained by one or more mobile payment services. The balance management system is implemented to obtain balance data associated with user accounts maintained by the one or more mobile payment services and corresponding to a user applying for a new secured payment instrument. This balance data, as described in greater detail herein, may be used to determine an initial credit limit for the secured payment instrument. This initial credit limit may be securitized according to the available balances associated with user accounts maintained by one or more mobile payment services.

At step 602, the secured instrument application system may receive an application for a new secured payment instrument. The application may include information corresponding to one or more user accounts associated with one or more mobile payment services, such as account credentials (e.g., usernames, passwords, cryptographic tokens, account numbers, etc.) that may be used to access these one or more user accounts. Further, the application may include information that may be used to perform a credit inquiry of the user's credit report to determine whether the user is qualified for a line of credit associated with a secured payment instrument. For instance, through the application or other request, the user may provide their legal name, birthdate, last four digits of their Social Security number, household income, and the like. Thus, through processing of this application, the secured instrument application system may identify personal and account information associated with the user at step 604.

At step 606, the balance management system may obtain the application, as well as any other information garnered from a user accounts datastore implemented by the payment instrument service, to perform a credit inquiry. For example, the balance management system may automatically submit a credit inquiry to a credit reporting service to obtain a credit evaluation for the user. The result of credit inquiry may include one or more credit scores associated with the user, the current amount of credit allocated to the user from different financial entities (including the payment instrument service, if any), the current amount of credit available to the user, and the like.

Based on the result of the credit inquiry, the balance management system, at step 608, may determine whether the user is approved for a new line of credit associated with a secured payment instrument. In an embodiment, the balance management system implements and dynamically trains a machine learning algorithm or artificial intelligence to determine whether the user is approved for the new line of credit. The machine learning algorithm or artificial intelligence may be implemented and trained to automatically, and dynamically, evaluate the applications submitted by users for new lines of credit, as well as these users' credit histories as provided by one or more credit reporting services, to determine whether these users are approved for these new lines of credit. For instance, for the user that submitted the application, the machine learning algorithm or artificial intelligence may process the provided application, the result of the full credit inquiry, and any existing user records from the user accounts datastore (such as the user accounts datastore 110 described above in connection with FIG. 1) to determine whether the user is approved for the new line of credit. For instance, based on the user's credit history, characteristics of the user (e.g., demographic information, etc.), and information provided in the application (e.g., current income, employment status, current employment title, length of employment, etc.), the machine learning algorithm or artificial intelligence may identify a cluster of similarly situated users according to one or more vectors of similarity (e.g., credit scores, changes in credit scores, spending habits, total amount of credit allocated, total amount of credit available, payment performance, demographic information, etc.). These similarly situated users may correspond to secured payment instruments issued to these account holders and/or to applications that have been rejected based on the one or more vectors of similarity. The machine learning algorithm or artificial intelligence, in some instances, may analyze a dataset of characteristics of users and accounts to determine whether to approve or reject the submitted application. This dataset may include historical data corresponding to the applications for new lines of credit submitted by different users, the decisions made in response to these applications (e.g., approve or deny), the users' performance in maintaining the lines of credit associated with these payment instruments in good standing, historical changes to the users' credit scores while maintaining these lines of credit, and the like.

At step 610, if the balance management system determines that the user is not approved for a new line of credit associated with a secured payment instrument, the balance management system may indicate that the user has not been approved for the applied for secured payment instrument. For instance, the balance management system may transmit a notification, through the secured instrument application system, to the user to indicate that the user has not been approved for the new line of credit. In some instances, the balance management system may further provide the user with a rationale for the rejection of their application for the new line of credit. For example, if the user was rejected due to a poor credit score and a history of payment delinquencies, the balance management system may generate a response that indicates that the poor credit score and the user's past history were contributing factors to the application being rejected. In some instances, any rationale provided may omit any specific metrics leading to rejection of the application. For example, the balance management system may omit actual credit score values, descriptions of individual events corresponding to negative contributing factors towards rejection, and the like.

At step 612, if the balance management system determines that the user is approved for a new line of credit associated with a secured payment instrument, the balance management system may obtain balance data from one or more mobile payment services that may maintain different user accounts associated with the user. For instance, the balance management system may automatically access these one or more mobile payment services to obtain balance data. The balance management system may use a corresponding set of credentials (e.g., usernames, passwords, cryptographic tokens, account numbers, routing numbers, etc.) associated with an account maintained by a mobile payment service to access the account in order to obtain the balance data. For instance, through an API call to a mobile payment service, the balance management system may provide the mobile payment service with the requisite set of credentials needed to access the account associated with the user. The mobile payment service may evaluate the provided set of credentials in order to authenticate the request and determine whether the user has provided the requisite authorization to allow the balance management system to access the account.

At step 614, the balance management system may process any obtained balance data associated with user accounts maintained by the one or more mobile payment services to determine the available credit for the new line of credit. For instance, as noted above, the balance management system may implement and dynamically train a machine learning algorithm or artificial intelligence to automatically determine the initial credit limit that is to be associated with the secured payment instrument based on the balance data corresponding to user accounts associated with the one or more mobile payment services, the user's credit evaluation, and historical data corresponding to the user and other users associated with the payment instrument service. As noted above, the machine learning algorithm or artificial intelligence may be implemented as a clustering algorithm that is trained to identify, based on one or more vectors of similarity (e.g., credit scores, changes in credit scores, balances corresponding to accounts associated with mobile payment services, changes in balances corresponding to accounts associated with mobile payment services, spending habits, total amount of credit allocated, total amount of credit available, payment performance, demographic information, etc.), clusters corresponding to similar accounts and/or account holders associated with previously issued secured payment instruments. These similar accounts and/or account holders may correspond to different credit limit determinations as a function of available balances corresponding to user accounts associated with the one or more mobile payment services. Further, these clusters of similar accounts and/or account holders may be identified based on the vectors of similarity. Thus, by training and implementing this clustering algorithm, the balance management system may determine an initial line of credit for the secured payment instrument.

In an embodiment, the balance management system can determine the initial credit limit and corresponding function using other techniques, such as classical algorithms or other executable processes. For example, the balance management system may automatically allocate, for the new secured payment instrument, a credit limit equal to the current available balance corresponding to a user account associated with a mobile payment service. Further, as described in greater detail herein, the balance management system may maintain a 1:1 correlation between the credit limit associated with the secured payment instrument and the available balance corresponding to the user account associated with the mobile payment service.

Once the balance management system has determined an initial credit limit for the new secured payment instrument, the balance management system may provide this initial credit limit to the secured instrument application system. The secured instrument application system may provide the user with information corresponding to the initial credit limit associated with the secured payment instrument and the corresponding user account associated with the mobile payment service that is to be used to securitize the secured payment instrument. Once the user has agreed to the terms and conditions, as well as to the line of credit, the secured instrument application system, at step 616, may issue the secured payment instrument to the user.

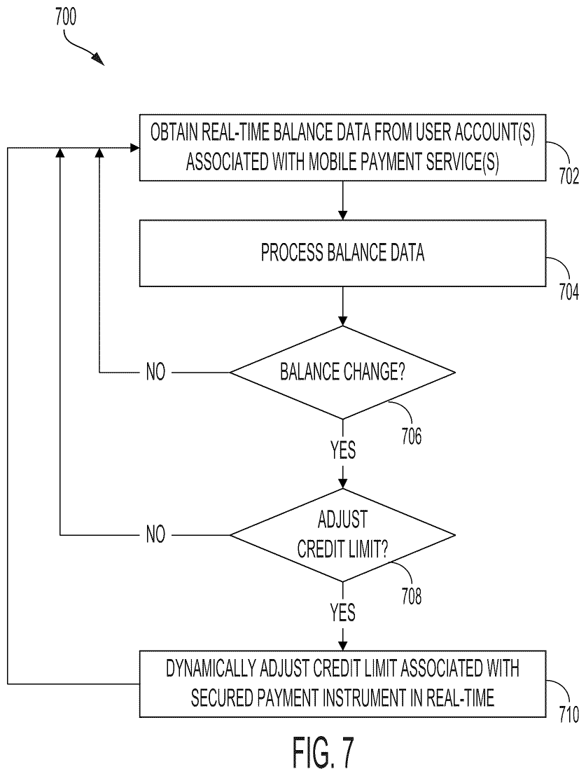

FIG. 7 shows an illustrative example of a process 700 for dynamically adjusting a credit limit associated with a secured payment instrument in real-time in response to changes to available balances corresponding user accounts associated with one or more mobile payment instruments in accordance with at least one embodiment. The process 700 may be performed by the balance management system. As noted above, the balance management system is implemented to automatically, and in real-time, process balance data associated with user accounts maintained by one or more mobile payment services to determine whether adjustments to credit limits associated with different secured payment instruments are required.

At step 702, the balance management system may automatically obtain real-time balance data associated with one or more user accounts maintained by one or more mobile payment services. This balance data may be obtained in real-time as transactions associated with user accounts maintained by the one or more mobile payment services occur. For instance, the balance management system may continuously, and in real-time, obtain a stream of data from the one or more mobile payment services corresponding to different user accounts maintained by the one or more mobile payment services and that may be linked to issued secured payment instruments. This stream of data may include balance data corresponding to user accounts maintained by the one or more mobile payment services, which may represent any real-time changes to the available balances associated with these user accounts as transactions involving these user accounts occur.

At step 704, the balance management system may automatically, and in real-time, process the balance data obtained from the one or more mobile payment services. As noted above, the balance data may provide updated balances associated with different user accounts maintained by the one or more mobile payment services. To process this balance data, the balance management system may obtain, from the user accounts datastore maintained by the payment instrument service and for each secured payment instrument, a current credit limit associated with the secured payment instrument. As noted above, the initial credit limit associated with a secured payment instrument may be determined based on the available balance associated with a corresponding user account maintained by a mobile payment service at the time of issuance of the secured payment instrument. Further, when issuing the secured payment instrument, the balance management system may define a function that may be used to calculate the credit limit associated with the secured payment instrument over time based on fluctuations to the available balance associated with the user account maintained by a mobile payment service. Accordingly, the balance management system may further obtain, from the user accounts datastore, the defined function, the previous available balance associated with the user account maintained by a mobile payment service, and the initial credit limit assigned to the particular secured payment instrument being reviewed.

At step 706, the balance management system may determine whether there has been a change to the available balance associated with a user account maintained by a mobile payment service. For instance, the balance management system may compare the current available balance for a user account maintained by a mobile payment service (as indicated in the obtained balance data) to historical balance data associated with the user account to determine whether there has been a change to the available balance associated with the user account. The historical balance data may be maintained in the user accounts datastore in association with an account corresponding to a secured payment instrument issued to a particular user. This particular user may also be the owner of the user account maintained by the mobile payment service. The balance management system may identify, from the historical balance data, the most recent available balance identified for the user account maintained by the mobile payment service prior to obtaining the newly obtained balance data. This operation may be performed simultaneously and in real-time for each user account maintained by the mobile payment service and for each corresponding secured payment instrument account.

If, based on this evaluation, the balance management system determines that there has been no change to the available balance associated with a user account maintained by a mobile payment service, the balance management system may determine that no adjustment to the credit limit associated with a corresponding secured payment instrument is required. Accordingly, the balance management system may proceed to obtain new balance data from the one or more mobile payment services in real-time as transactions involving user accounts maintained by these one or more mobile payment services occur. Thus, if no change to the available balance is detected, the balance management system may restart the process 700.

If the balance management system detects a change to the available balance associated with a user account maintained by a mobile payment service, the balance management system, at step 708, may determine whether to dynamically adjust the credit limit associated with a corresponding secured payment instrument. For example, the balance management system may use the balance data from a mobile payment service, the current credit limit associated with the secured payment instrument, the initial credit limit associated with the secured payment instrument, and a correlation function that defines a relationship between changes to an available balance associated with a user account maintained by a mobile payment service with changes to the credit limit associated with the secured payment instrument to define a new credit limit for the secured payment instrument. Returning to a previously described illustrative example, assume that the initial credit limit associated with the secured payment instrument is $1,000 and the current credit limit associated with the secured payment instrument is $900. Further, the balance management system determines, based on the obtained balance data, that the available balance associated with a corresponding user account maintained by the mobile payment service is reduced from $900 to $800. If the defined correlation function corresponds to a 1:1 correlation between the credit limit associated with the secured payment instrument and the available balance associated with the corresponding user account maintained by the mobile payment service, the balance management system may dynamically, and in real-time, reduce the credit limit associated with the secured payment instrument from $900 to $800 in order to match the available balance associated with the corresponding user account maintained by the mobile payment service.

As noted above, there may be some instances where the balance data may indicate that there has been an increase in the available balance that results in an available balance that exceeds the initial available balance used to determine the initial credit limit associated with the secured payment instrument. If the balance management system determines that the new available balance associated with the user account maintained by the mobile payment service is greater than this initial credit limit, the balance management system may determine whether the credit limit may be increased beyond the initial credit limit associated with the secured payment instrument. For instance, the balance management system may obtain a new credit evaluation associated with the user to determine whether the credit limit associated with the secured payment instrument may be increased according to the correlation function defined for the secured payment instrument. Based on this credit evaluation, the balance management system may determine whether the credit limit may be increased beyond the initial credit limit associated with the secured payment instrument according to the correlation function.

In some instances, the credit limit associated with the secured payment instrument may be capped according to the to the current available balance associated with the user account maintained by the mobile payment service. For instance, if the initial credit limit associated with the secured payment instrument is $1,000 and the available balance associated with a user account maintained by the mobile payment service has increased to $1,200, if the secured payment instrument is assigned a 2:1 correlation function, the balance management system may not increase the credit limit associated with the secured payment instrument from $1,000 to $1,400, as this would exceed the available balance associated with a user account maintained by the mobile payment service. Instead, the credit limit associated with the secured payment instrument may be increased to the current available balance of $1,200. Further, the balance management system may indicate that fluctuations to the available balance associated with the user account maintained by the mobile payment service may not impact the credit limit unless the available balance falls below $1,200.

If the balance management system determines, based on the new credit evaluation, that the credit limit associated with the secured payment instrument may not be increased beyond the initial credit limit, the balance management system may maintain the initial credit limit regardless of how much the available balance associated with the user account maintained by the mobile payment service exceeds this initial credit limit. Additionally, the balance management system may indicate that fluctuations to the available balance associated with the user account maintained by the mobile payment service may not impact the credit limit unless the available balance falls below the initial credit limit. Thus, as fluctuations to the available balance associated with the user account maintained by the mobile payment service occur, the balance management system may dynamically, and in real-time, update the credit limit associated with the secured payment instrument subject to current credit evaluations and identified correlation functions.

If the balance management system determines that no adjustment to the credit limit associated with the secured payment instrument is required, the balance management system may proceed to obtain new balance data from the one or more mobile payment services in real-time as transactions involving user accounts maintained by these one or more mobile payment services occur, restarting the process 700. However, if the balance management system determines that the credit limit associated with the secured payment instrument is to be adjusted as a result of a change to the available balance associated with a user account maintained by the mobile payment service, the balance management system, at step 710, may dynamically adjust the credit limit associated with the secured payment instrument in real-time. For instance, the balance management system may update the user accounts datastore to indicate the new credit limit associated with the secured payment instrument. This may allow a user associated with the secured payment instrument to monitor, in real-time, any changes to their credit limit associated with the secured payment instrument. Further, this allows the transaction processing system of the payment instrument service to determine whether to approve or deny any pending transactions for which the secured payment instrument has been used.

It should be noted that the process 700 may be performed continuously and simultaneously for each of the secured payment instrument accounts maintained by the payment instrument service. For instance, as real-time balance data is obtained from different mobile payment services, the balance management system may continuously and simultaneously perform the process 700 for each of the secured payment instrument accounts maintained by the payment instrument service. For instance, the balance management system may dynamically, and in real-time or near real-time, detect any balance changes and consequently adjust the credit limits associated with any secured payment instruments that are identified as being able to have their credit limits adjusted. Further, as these determinations are being made, the balance management system may continuously and simultaneously obtain new real-time balance data from the different mobile payment services. Thus, the balance management system may provide real-time credit limit adjustments for any number of secured payment instruments as the real-time balance data is obtained from different mobile payment services.

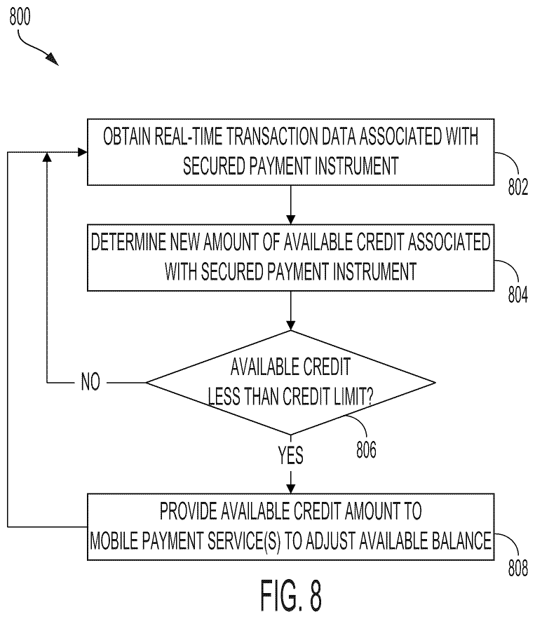

FIG. 8 shows an illustrative example of a process 800 for dynamically adjusting an available balance corresponding to a user account associated with a mobile payment service based on transaction data associated with a secured payment instrument in accordance with at least one embodiment. The process 800 may be performed by the balance management system implemented by the payment instrument service. As noted above, the payment instrument service may implement a transaction processing system that may continuously, in real-time, process transactions associated with a secured payment instrument. For instance, when a user utilizes their secured payment instrument at a point-of-sale or through an online merchant, the transaction processing system may process a transaction corresponding to use of the secured payment instrument by ensuring that the account associated with the secured payment instrument may be used for the particular transaction. If the required amount is not available (e.g., applying the required amount to the account would exceed the credit limit), the transaction processing system may automatically decline the transaction. Alternatively, if the transaction processing system determines that the transaction may be processed (e.g., applying the required amount to the account would not exceed the credit limit), the transaction processing system may automatically approve the transaction, provide payment to the corresponding merchant, and deduct the amount from the available line of credit associated with the secured payment instrument.

At step 802, the balance management system may obtain real-time transaction data associated with the secured payment instrument. For instance, the balance management system may obtain transaction data associated with the secured payment instrument from a transaction processing system, in real-time, as transactions associated with the secured payment instrument occur. The transaction data may indicate any transactions for which the secured payment instrument was used, resulting in a charge to the secured payment instrument. Additionally, the transaction data may indicate any payments made by the user or other entity to settle any balances associated with the secured payment instrument. For instance, a user or other entity may be required to provide at least a minimum payment according to pre-defined billing cycles to reduce or otherwise settle any outstanding balances associated with the secured payment instrument. Thus, the transaction data may include various charges and balance payments made by a user or other entity as they occur.

At step 804, the balance management system may determine the new amount of available credit associated with the secured payment instrument. For instance, the balance management system may dynamically, and in real-time, process the real-time transaction data to determine the net change to the amount of available credit associated with the secured payment instrument. As an illustrative example, if the real-time transaction data includes a purchase for $60 and an account payment of $60, the balance management system may determine that there is no net change to the amount of available credit associated with the secured payment instrument. As another illustrative example, if the real-time transaction data includes a $100 purchase and an account payment of $25, the balance management system may determine that there is a net $75 reduction to the amount of available credit associated with the secured payment instrument.

At step 806, the balance management system determines whether the amount of available credit associated with the secured payment instrument is less than the credit limit associated with the secured payment instrument. As noted above, the credit limit associated with the secured payment instrument may be securitized by an available balance associated with a user account maintained by a mobile payment service. Further, as the amount of available credit associated with the secured payment instrument is reduced according to transactions involving the secured payment instrument, a corresponding amount from the available balance associated with the user account maintained by the mobile payment service may be held in abeyance until the user pays off the existing balance associated with the secured payment instrument. This amount held in abeyance may be used to further securitize the secured payment instrument such that, if the user defaults on payment of any existing balances associated with the secured payment instrument, the payment instrument service may leverage this amount held in abeyance to settle any outstanding balances associated with the secured payment instrument.

If the balance management system determines that the amount of available credit is equal to the credit limit associated with the secured payment instrument, the balance management system may determine that there is no outstanding balance associated with the secured payment instrument. Accordingly, the balance management system may determine that no amount needs to be held in abeyance from the available balance associated with a user account maintained by the mobile payment service. The balance management system may, thus, continue to obtain and process, in real-time, transaction data associated with the secured payment instrument, thereby restarting the process 800.

If the balance management system determines that the amount of available credit associated with the secured payment instrument is less than the credit limit, the balance management system may provide the amount of available credit to the mobile payment service. The amount may be provided in the form of transaction data, which may indicate the credit limit associated with the secured payment instrument and the current available amount of credit associated with the secured payment instrument. In some instances, the balance management system may provide the actual transaction data obtained from the transaction processing system to the mobile payment service.

As noted above, in response to obtaining the amount of available credit or the transaction data from the balance management service, the mobile payment service may dynamically, and in real-time, adjust the available balance associated with the user account such that the available balance is reduced according to the amount associated with the transactions completed using the secured payment instrument. While the user account maintained by the mobile payment service may still maintain the full amount for the user account, the mobile payment service may hold any balances associated with the secured payment instrument in abeyance until the user pays off these balances associated with the secured payment instrument. As the user reduces their existing balance associated with the secured payment instrument, a portion of the available balance held in abeyance by the mobile payment service equal to this reduction to their existing balance may be released for use.

It should be noted that the process 800 may be performed continuously and simultaneously for all of the secured payment instruments maintained by the payment instrument service. For instance, the balance management system may dynamically obtain real-time transaction data for each of the secured payment instruments maintained by the payment instrument service and associated with different users as corresponding transactions occur. Based on these transactions, the balance management system may perform steps 804-808 for each of these secured payment instruments simultaneously and in real-time to provide the available credit amounts for each of these secured payment instruments to the corresponding mobile payment services.

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In an embodiment, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed payment instrument service, the systems of the payment instrument service, and the systems and methods for dynamically, and in real-time, adjusting a credit limit associated with a secured payment instrument can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, adjusting a credit limit associated with a secured payment instrument described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described herein, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

In an embodiment, the computing device 902 can be connected to one or more additional computing devices and/or services such as merchant computing device 936 and/or a point-of-sale service 934 via the network 922 and using a connection such as the network interface 920. In an embodiment, the point-of-sale service 934 is separate from the merchant computing device 936. In an embodiment, the point-of-sale service 934 is executing on the merchant computing device 936. In an embodiment, the point-of-sale service 934 is executing as one or more services (e.g., the service 930 and/or the service 932) operating within the environment of the computing resources provider. As used herein, a point-of-sale service 934 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 936 to interact with the point-of-sale service 934. In an embodiment, the merchant computing device 936 is a dedicated point-of-service (POS) terminal. In an embodiment, the merchant computing device 936 is a cash register system. In an embodiment, the merchant computing device 936 is an application or web service operating on a computing device such as the computing device 902 described herein. In such an embodiment, the application or web service may be provided by a financial services system (e.g., a bank, a transaction processing system, an inventory management system, or some other such financial services system). In an embodiment, the merchant computing device 936 includes an auxiliary device or system to execute tasks associated with the point-of-sale service 934 (e.g., a payment instrument processing device attached to a smart phone or tablet). In an embodiment, the merchant computing device 936 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 936 is a virtual device (e.g., a virtual kiosk) such as the virtual devices described herein. Although not illustrated here, in an embodiment, the merchant computing device 936 may be one of a plurality of devices that may be interconnected using a network such as the network 922.

In an embodiment, the computing device 902 can be connected to one or more additional computing devices and/or services such as a payment instrument service 938 via the network 922 and using a connection such as the network interface 920. In an embodiment, the payment instrument service 938 connects directly with the point of sale service 934. In an embodiment, elements of the payment instrument service 938 are executing on the merchant computing device 936. In an embodiment, the payment instrument service 938 is executing as one or more services (e.g., the service 930 and/or the service 932) operating within the environment of the computing resources provider. As used herein, a payment instrument service 938 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 938 are running as an application or web service operating on a computing device such as the computing device 902 described herein. In such an embodiment, the application or web service of the payment instrument service 938 may be provided by a financial services system (e.g., a bank, a transaction processing system, an inventory management system, or some other such financial services system). In an embodiment, elements of the payment instrument service 938 are running on an auxiliary device or system configured to execute tasks associated with the payment instrument service 938 (e.g., uses a payment instrument processing device attached to a smart phone or tablet). In an embodiment, elements of the payment instrument service 938 are running on virtual device such as those described herein. Although not illustrated here, in an embodiment, the payment instrument service 938 may be running on one or more of a plurality of devices that may be interconnected using a network such as the network 922.

In an embodiment, the computing device 902 can be connected to one or more additional computing devices and/or services such as an authentication service 940 via the network 922 and using a connection such as the network interface 920. In an embodiment, the authentication service 940 is an element of the payment instrument service 938. In an embodiment, the authentication service 940 is separate from the payment instrument service 938. In an embodiment, the authentication service 940 connects directly with the point of sale service 934. In an embodiment, elements of the authentication service 940 are executing on the merchant computing device 936. In an embodiment, the authentication service 940 is executing as one or more services (e.g., the service 930 and/or the service 932) operating within the environment of the computing resources provider. As used herein, an authentication service 940 is a service used by one or more merchants to authenticate transactions associated with payment instruments. An authentication service may be a third-party service that provides secure and verified authorization of the transactions.

In an embodiment, elements of the authentication service 940 are running as an application or web service operating on a computing device such as the computing device 902 described herein. In such an embodiment, the application or web service of the authentication service 940 may be provided by a financial services system (e.g., a bank, a transaction processing system, an inventory management system, or some other such financial services system). In an embodiment, elements of the authentication service 940 are running on an auxiliary device or system configured to execute tasks associated with the authentication service 940 (e.g., provides authentication using payment instrument processing device attached to a smart phone or tablet). In an embodiment, elements of the authentication service 940 are running on virtual device such as those described herein. Although not illustrated here, in an embodiment, the authentication service 940 may be running on one or more of a plurality of devices that may be interconnected using a network such as the network 922.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap bet ween these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving an application for a secured payment instrument, wherein the application includes account information corresponding to a payment service account associated with a user;
obtaining balance data associated with the user, wherein the balance data corresponds to an available balance associated with the payment service account, and wherein the balance data is obtained using the account information to access the payment service account;
determining a credit limit associated with the secured payment instrument, wherein the credit limit is determined based on the balance data;
issuing the secured payment instrument, wherein the secured payment instrument is secured according to the credit limit and an available balance associated with the payment service account;
automatically obtaining new balance data associated with the payment service account, wherein the new balance data is automatically obtained in real-time as transactions using the payment service account are performed; and
dynamically adjusting the credit limit associated with the secured payment instrument, wherein the credit limit associated with the secured payment instrument is dynamically adjusted in real-time based on the new balance data.

2. The computer-implemented method of claim 1, further comprising:
obtaining transaction data associated with the secured payment instrument, wherein the transaction data is obtained in real-time as secured payment instrument transactions are performed;
determining an amount of available credit associated with the secured payment instrument, wherein the amount is determined based on the transaction data; and
providing the amount, wherein when the amount is obtained by a payment service associated with the payment service account, the available balance is dynamically adjusted according to the amount.

3. The computer-implemented method of claim 1, further comprising:
obtaining a credit evaluation corresponding to the user, wherein the credit evaluation is obtained based on the application; and
using the credit evaluation to adjust the credit limit before issuing the secured payment instrument.

4. The computer-implemented method of claim 1, wherein the secured payment instrument is secured without a security deposit.

5. The computer-implemented method of claim 1, further comprising:
dynamically training a machine learning algorithm to generate correlation functions for adjusting credit limits associated with different secured payment instruments as different balance data associated with different users is obtained, wherein the machine learning algorithm is dynamically trained using a dataset of account characteristics;
processing the balance data through the machine learning algorithm to identify a correlation function for the secured payment instrument; and
applying the correlation function based on the new balance data to dynamically adjust the credit limit.

6. The computer-implemented method of claim 1, wherein the credit limit is dynamically adjusted as a result of the new balance data indicating that the available balance is less than the credit limit.

7. The computer-implemented method of claim 1, further comprising:
automatically tracking a credit performance associated with the user, wherein the credit performance is tracked in real-time; and
dynamically adjusting the credit limit according to the credit performance.

8. A system, comprising:
one or more processors; and
memory storing thereon instructions that, as a result of being executed by the one or more processors, cause the system to:
receive an application for a secured payment instrument, wherein the application includes account information corresponding to a payment service account associated with a user;
obtain balance data associated with the user, wherein the balance data corresponds to an available balance associated with the payment service account, and wherein the balance data is obtained using the account information to access the payment service account;
determine a credit limit associated with the secured payment instrument, wherein the credit limit is determined based on the balance data;
issue the secured payment instrument, wherein the secured payment instrument is secured according to the credit limit and an available balance associated with the payment service account;
automatically obtain new balance data associated with the payment service account, wherein the new balance data is automatically obtained in real-time as transactions using the payment service account are performed; and
dynamically adjust the credit limit associated with the secured payment instrument, wherein the credit limit associated with the secured payment instrument is dynamically adjusted in real-time based on the new balance data.

9. The system of claim 8, wherein the instructions further cause the system to:
obtain transaction data associated with the secured payment instrument, wherein the transaction data is obtained in real-time as secured payment instrument transactions are performed;
determine an amount of available credit associated with the secured payment instrument, wherein the amount is determined based on the transaction data; and
provide the amount, wherein when the amount is obtained by a payment service associated with the payment service account, the available balance is dynamically adjusted according to the amount.

10. The system of claim 8, wherein the instructions further cause the system to:
obtain a credit evaluation corresponding to the user, wherein the credit evaluation is obtained based on the application; and
use the credit evaluation to adjust the credit limit before issuing the secured payment instrument.

11. The system of claim 8, wherein the secured payment instrument is secured without a security deposit.

12. The system of claim 8, wherein the instructions further cause the system to:
dynamically train a machine learning algorithm to generate correlation functions for adjusting credit limits associated with different secured payment instruments as different balance data associated with different users is obtained, wherein the machine learning algorithm is dynamically trained using a dataset of account characteristics;
process the balance data through the machine learning algorithm to identify a correlation function for the secured payment instrument; and
apply the correlation function based on the new balance data to dynamically adjust the credit limit.

13. The system of claim 8, wherein the credit limit is dynamically adjusted as a result of the new balance data indicating that the available balance is less than the credit limit.

14. The system of claim 8, wherein the instructions further cause the system to:
automatically track a credit performance associated with the user, wherein the credit performance is tracked in real-time; and
dynamically adjust the credit limit according to the credit performance.

15. A non-transitory, computer-readable storage medium storing thereon executable instructions that, as a result of being executed by one or more processors of a computer system, cause the computer system to:
receive an application for a secured payment instrument, wherein the application includes account information corresponding to a payment service account associated with a user;
obtain balance data associated with the user, wherein the balance data corresponds to an available balance associated with the payment service account, and wherein the balance data is obtained using the account information to access the payment service account;
determine a credit limit associated with the secured payment instrument, wherein the credit limit is determined based on the balance data;
issue the secured payment instrument, wherein the secured payment instrument is secured according to the credit limit and an available balance associated with the payment service account;
automatically obtain new balance data associated with the payment service account, wherein the new balance data is automatically obtained in real-time as transactions using the payment service account are performed; and
dynamically adjust the credit limit associated with the secured payment instrument, wherein the credit limit associated with the secured payment instrument is dynamically adjusted in real-time based on the new balance data.

16. The non-transitory, computer-readable storage medium of claim 15, wherein the executable instructions further cause the computer system to:
obtain transaction data associated with the secured payment instrument, wherein the transaction data is obtained in real-time as secured payment instrument transactions are performed;
determine an amount of available credit associated with the secured payment instrument, wherein the amount is determined based on the transaction data; and
provide the amount, wherein when the amount is obtained by a payment service associated with the payment service account, the available balance is dynamically adjusted according to the amount.

17. The non-transitory, computer-readable storage medium of claim 15, wherein the executable instructions further cause the computer system to:
obtain a credit evaluation corresponding to the user, wherein the credit evaluation is obtained based on the application; and
use the credit evaluation to adjust the credit limit before issuing the secured payment instrument.

18. The non-transitory, computer-readable storage medium of claim 15, wherein the secured payment instrument is secured without a security deposit.

19. The non-transitory, computer-readable storage medium of claim 15, wherein the executable instructions further cause the computer system to:
dynamically train a machine learning algorithm to generate correlation functions for adjusting credit limits associated with different secured payment instruments as different balance data associated with different users is obtained, wherein the machine learning algorithm is dynamically trained using a dataset of account characteristics;
process the balance data through the machine learning algorithm to identify a correlation function for the secured payment instrument; and
apply the correlation function based on the new balance data to dynamically adjust the credit limit.

20. The non-transitory, computer-readable storage medium of claim 15, wherein the credit limit is dynamically adjusted as a result of the new balance data indicating that the available balance is less than the credit limit.

21. The non-transitory, computer-readable storage medium of claim 15, wherein the executable instructions further cause the computer system to:
automatically track a credit performance associated with the user, wherein the credit performance is tracked in real-time; and
dynamically adjust the credit limit according to the credit performance.
